(19) United States
(12) Patent Application Publication
(10) Pub. No.: US 2013/0297467 A1
(43) Pub. Date: Nov. 7, 2013

(54) METHOD AND SYSTEM FOR ACCOUNTING FOR DOWNLOAD TRANSACTIONS AND SOCIAL NETWORK INTERACTION

(71) Applicants: ADAM KIDRON, BRONX, NY (US); BRUCE HENDERSON, BROOKLYN, NY (US); RICHARD ZINN, MURRIETA, CA (US); KYLE KARTCHNER, RIVERTON, UT (US)

(72) Inventors: ADAM KIDRON, BRONX, NY (US); BRUCE HENDERSON, BROOKLYN, NY (US); RICHARD ZINN, MURRIETA, CA (US); KYLE KARTCHNER, RIVERTON, UT (US)

(73) Assignee: BOINC/BEYOND HOLDINGS, LLC, NEW YORK, NY (US)

(21) Appl. No.: 13/720,740

(22) Filed: Dec. 19, 2012

Related U.S. Application Data
(63) Continuation of application No. 13/124,018, filed on Aug. 10, 2011, now abandoned.
(60) Provisional application No. 61/106,845, filed on Oct. 20, 2008.
(60) Provisional application No. 61/220,446, filed on Jun. 25, 2009.

(51) Int. Cl. G06Q 40/00

(52) U.S. Cl. CPC G06Q 40/10
USPC 705/30

(57) ABSTRACT

The invention is a method and system for establishing a social networking system. A network platform for storing content of interest to a particular group is established. An interface means provides a pathway to access the content. The supporting platform comprises hardware supporting a series of applications which include a points system application for awarding points to a system member in respect of certain transactions facilitated by an exchange engine. A hierarchical structure is created within the system and is determined by establishing a ranking structure and placing each of the members at a particular rank level based upon a pre-determined level of points within their accounts. Each of the members receives access to a set of rewards; the rewards being made available to a particular rank level. Additionally, access to certain functionality within the social networking system is determined in accordance with rank structure.

### CROSS REFERENCE TO RELATED APPLICATIONS

This application is a continuation of and relates to and claims priority to, under 37 CFR §1.53(b), U.S. Ser. No. 13/124,018 filed Apr. 13, 2011, the entire contents of which are incorporated herein by reference, which in turn is related to and claims priority to, Ser. No. PCT/US2009/061309 filed Oct. 20, 2009, which in turn and also claims to relates to and claims priority from U.S. Provisional Application Ser. No. 61/106,845, filed Oct. 20, 2008 and to U.S. Provisional Application Ser. No. 61/220,446, filed Jun. 25, 2009, the entire contents of each of which is also fully incorporated herein fully by reference.

Related Applications: This application family has the same filing dates as PCT Ser. No. PCT/US2009/061307 filed Oct. 20, 2009 (Attorney Docket No.:BEYON.P004) and PCT Ser. No. PCT/US2009/061296 filed Oct. 20, 2009 (Attorney Docket No.:BEYON.P003), the entire contents of each of which are incorporated herein gully by reference.

### BACKGROUND OF THE INVENTION

1. Field of the Invention

The present invention relates to a data processing system for accounting for music and/or video plays through the system, together with the ability to aggregate data into a database and to manage a social networking exchange. More specifically, the present invention relates to a system capable of tracking and managing plays per file from digital audio or video devices such as portable MP3 players, cell phones, computers, GPS systems, etc. (collectively “music enabled machines” or “MEMS”) reporting to individual repositories. The system tracks the plays per song/per user to establish comprehensive accounting and demographic records. Additionally, the system tracks and manages a social exchange network that is built around the activities of the users including plays per song, downloads, sharing and referring so as to promote search for audio and video files within the system. Interoperative data mining, reporting, reader and reporter functions are interposed throughout the system.

2. Description of the Related Art

The related art involves the royalty collection efforts of the music industry as those royalties pertain to the playing of copyrighted digital music tracks and video. The music industry has undergone change in the past 130 years in ways that are directly linked to changes in social awareness and, more specifically, to advances in technology. The rise of digital music has led to extreme changes in the music and related video distribution model.

For many years, copyright holders were paid upon the sale of records or tapes that could be kept track of in a relatively easy manner. In addition, pay-for-play was also a royalty generator which was handled by such performance rights organizations (PROs) as: the American Society of Composers, Authors and Publishers (ASCAP); Broadcast Music Inc. (BMI); and, the Society of European Stage Authors & Composers (SESAC), among others. PROs provide a number of different functions for their constituents, but perhaps the most important of these functions is royalty collection for performances, sales, download and distribution of music and related video.

Recording industry revenues in the US reached its zenith in 1999 with revenues of $14.6 billion. Since that time, the industry has undergone a steady decline, so that it was at $11.0 billion by the end of 2006. On the other hand, digital music revenue for the United States has grown to approximately $2.0 billion; and, is expected to reach approximately $5.3 billion by 2012.

With the advent of digital technology as applied to music, the tangible medium that had been so easy to track for royalty purposes, was essentially a shadow of the digital composition. Digital files could be downloaded via the internet to a personal computer, or any one of a number of handheld digital devices. Tracking the number of downloads for royalty purposes became difficult. Digital music distributors such as the iTunes™ store and the Zune Marketplace™ (each of which has MP3 and other type digital playing devices for sale in the market) are software-based, online, digital media stores that have kept a degree of legitimacy to the download market.

Online stores receive their content from record labels (the manufacturers of the recording masters) such as Sony BMG, Universal and Warner. Royalties are calculated by determining the number of downloads for a particular digital file, multiplying that number by a royalty rate, and paying the record labels accordingly. Stores such as iTunes™ are responsible for tracking millions of unit sales over short periods of time. For instance, in the first five days of its existence (April 2003), iTunes™ sold more than 1,000,000 units. They reached the one billion mark in February 2006; and, they had sold five billion tracks as of June 2008. As the number of compatible devices proliferates, the growth of the digital download market increases that much more quickly.

The steady growth of digital downloading, however, has begun to erode the market for traditional album sales. To understand where we are, it is important to understand how we got here—from the phonograph cylinder to the CD-ROM.

Initially, the phonograph cylinder dominated the recorded sound market in the early 1880s through to the end of World War I. The first sound recordings were recorded to tinfoil wrapped around a rotating cylinder. Shortly thereafter, the tinfoil surface gave way to the use of a wax surface which recorded sound in grooves cut into the wax outer surface of the cylinder.

The wax cylinders evolved, but they soon gave way to the hard plastic cylinders; the first of which were made with celluloid and could be played thousands of times before wearing out.

Shortly after the development of the cylinder devices came the lateral cut disc record which found its early success in the toy industry. The two technologies existed side by side for a number of years until the expiration of the early disc patents brought increased competition into that market. Early disc records used a variety of playing surfaces, including even hardened rubber; but, by the turn of the century, these had been replaced by “shellac” records that used a compound of: shellac; cotton filler; powdered slate; and, a lubricant. Over time, shellac records would give up their dominance to vinyl.

In the early 1920s, phonographs playing disc (on the rise) and cylinders (on the decline) were the primary means of getting music to the average listener. This soon began to change with the proliferation of radios in the average household. Though developing at the turn of the 20^{th} Century as a means of broadcasting morse and then voice traffic, radio transmission soon found itself as a platform for entertainment. And, in the 1930s, because of the economic Depression which limited family expenditures for things like entertainment, the radio was a means for listening to music without having to purchase it.

From a social history aspect, marketing found ways of distributing music through the installation of juke boxes in bars, clubs and diners. Listeners “discovered” jazz which had been previously downplayed for social reasons; and, by the 1950s came the rise of rock and roll and the explosion in the number of young people getting involved in music. In parallel with this development, was the increasing popularity of the television.

As music distribution grew and found new outlets, the amount of money available to the record companies, recording artists, and other producers grew as well. Radio fueled the popularity of artists which in turn gave rise to an increase in record sales. By the 1950s, television too was contributing to the growth of the music industry.

Records began to compete with tapes (reel-to-reel, 8-track, and cassette) for market share; and even as the reel-to-reel and 8-track entries quickly dropped out of the market, new entrants such as the CD-ROM came in. The CD-ROM was a particularly strong medium because it took the old analog recordings and digitally reproduced them, thus making the medium ubiquitous because it played everywhere from cars and home stereos to portable devices (Walkman) and computers. The ability to digitize music brought quality sound to a medium that had a great storage capacity. Then came the MP3 player.

The MPEG-1 Audio Layer 3 format (commonly referred to as MP3) is one of a variety of digital audio encoding formats that utilizes lossy data compression to compress digital data with limited quality loss. MP3 devices made it practical to download and store digital audio tracks that would otherwise be memory prohibitive. With the increases in memory capacity in computers and other similar devices; including, mobile phones, game consoles, digital cameras, GPS navigation devices, etc., all referred to hereafter as “MEMs” or music enabled machines, that have occurred over the last years, it has become easier to manage digital audio libraries through downloading services such as iTunes™ and Zune Marketplace™.

Unfortunately, now because of the evolution of the marketplace, the past solutions can no longer effectively function.

What is not appreciated by the prior art is that business models sometimes have to change to reflect the social change around them. The inventors have recognized the need to change the royalty models that exist to reward recording artists and copyright holders for their creativity and innovation. Collecting revenues based on small box distribution needs to be re-visited when the small box gives way to digital downloads. Additionally, social interaction, data mining, royalty accounting, etc., particularly with music based consumption, is no longer tied to physical interaction. Social networking sites (such as FaceBook™ and MySpace™) have become a way of life for a younger generation that eschews personal face-to-face meetings for the exchange found in chat rooms, text messaging, and e-mail.

Accordingly, there is a need for an improved method and system for calculating and collecting royalties, that in turn rewards those innovators and artists whose creativity is desired in the market. Additionally, there is a need to shift the collection of revenues from the individual user (downloader) of the music/video, or the music/video downloading services (distributor) to the manufacturer of the platforms that store, play and forward the music and video files; or, optionally, to spread the collection of revenues to the manufacturers. Further, there is a need to link the social networking aspects of a system that is tied in to the downloading of digital files. In that way, the social networking system creates its own demand which in turn drives the distribution model.

### ASPECTS AND SUMMARY OF THE INVENTION

An aspect of the present invention is to provide a method and system for providing a hierarchical structure within a social networking system.

Another aspect of the present invention is to provide a platform for a social networking site that will drive interest and social exchange on a variety of levels aimed to increase music and related video distribution while tracking market trends and demographics for increased market awareness and understanding,

The present invention relates to a method and system for establishing a social networking system. The method steps begin with establishing a network platform for storing content of interest to a particular group. The platform comprises several hardware components which support a series of applications. Included within the set of applications is a points system application for awarding one or more points to an individual system member within the group in respect of a transaction engaged in by that individual member within the social networking system. The points system application is capable of monitoring a set of one or more transactions, which are facilitated by an exchange engine resident within the social networking system.

Available system content includes a library of music or video tracks; the tracks capable of being accessed individually by system members. Other content includes: music tracks; artist data; genre data; video files; and, social interaction information.

An interface means, or remote node, is made available to a set of members of the particular group and for establishing a pathway for one or more individual members of the group to be able to access the content and accumulate points awarded by the points system application. The interface means can be a handheld, portable, wireless communications device, or a personal computer, capable of accessing the internet. The interface means has a monitor capable of displaying graphic images received via the interface means.

A system account for each of the individual members within the social networking system is established for aggregating points awarded to a respective individual member. A hierarchical structure is created within the social networking system. The hierarchical structure is determined by establishing a ranking structure and placing each of the individual members at a particular rank level based upon a pre-determined level of points within the account of the individual member. Each of the social networking members receives access to a set of one or more rewards; the rewards being made available to a particular rank level and by at least one sponsor of the social networking system. Additionally, access to certain functionality within the social networking system is determined in accordance with rank structure.

The transactions comprise activities selectable from a group including, but not limited to: selection of a music track for downloading by a social networking member; exchanging music tracks members; posting a playlist; having other social networking members select a music track that corresponds to a music track identified on the playlist; posting reviews of music tracks; and, having other social networking members access reviews.

The system of the invention comprises a network platform for storing and accessing content. There is provided an exchange engine for facilitating exchange of certain content; and, a points system application for monitoring the exchange of the content and for rewarding certain classes of exchange with one or more points. A rating engine assesses a set of one or more points in respect of an individual exchange. Additionally, there is provided a set of one or more servers, such as edge, application, database and content servers, and a plurality of applications for allowing each system user to participate in social exchange within said social networking system. The social interchange occurs, in part, by accessing certain user profiles as content; and, wherein a set of one or more links is established within the profile, for allowing system users to migrate from the profile to site pages determined by the link.

The system itself can store audio or video files for download or sharing; but, in addition these files can be accessed by linking to file repositories. The inventive method establishes an interoperative access network for access to one or more repositories of digital audio/video files. To access the system, a program is installed in one or more digital audio/video enabled devices, wherein the program is capable of recognizing the MEMs device as an earlier ‘authorized or licensed device’ and to thereafter enable accessing and downloading of one or more digital audio and/or video files that have been selected by a user of the digital audio/video enabled device; this also enables tracking, storing and reporting by the system of the aggregate plays per song per artist from the user's MEMs device. The selection is made through an interface routine embedded in the digital audio/video enabled device and accessed through its display. The digital audio/video file can be downloaded by the system to the enabled and recognized licensed MEM device, and a record of the download is created and stored within a memory of the audio/video file distribution system along with all plays per song per artist from the user's MEMs device since the last time it was synced to the internet, and optionally the device itself.

The system collects data relative to each transaction that occurs. Data is aggregated in accordance with a predetermined profile wherein the profile is representative of: the name of an audio or video file; accounting categories; usage and demographic data; music and video preferences; etc. From the aggregated data, a custom report can be produced in accordance with a predetermined format. These reports can be specifically targeted to the payment of royalties or license fees; or, they can be related to user or industry demographics. Reports can be displayed on a system monitor, printed to a local or networked printer, or simply transmitted to an out of system location for third party use. Based on usage data, the system is capable of generating a payment to a stakeholder such as a repository or royalty collective. The payments are based upon negotiated royalty or fee rates and applied to transaction (plays per song/video) volumes on a monthly or quarterly basis. The advantage is that the individual device user does not have to pay any royalty for any download of a digital file. Rather, a fee can be paid by a device manufacturer for the right to include the system routine with the device, and the pay for play format becomes transparent to the user.

Selection of any particular file, whether audio or video, is accomplished by accessing an intelligent search field from the display of the digital audio/video enabled device. A category of search is selected from a list of categories, and a name or parameter associated with the selected category is chosen. The system searches along a path to access the appropriate file from its repository for the specific digital audio or video file representative of the entered name or parameter. If the system locates a match between the entered name or parameter and the desired file resident within one of the repositories, then the system displays a song or video title of the matched file; and, the user can then select a matched file name for download from the repository to the digital audio/video enabled device. If no match is made, then a no match indication is displayed to the device user.

The digital audio/video smart internet enabled device can additionally act as a user portal to access and participate in a social networking exchange hosted by the audio file distribution system. The access and participation in the social networking exchange is enabled by embedding a routine in the audio/video file distribution system that allows the user to select an option from a menu displayed on the internet enabled device so as to enter the social networking exchange. The user makes the selection, enters the exchange, and can post messages through a short string (typically 140 characters), or link to other user playlists or content sources. The short string message itself can become an enabling platform for disseminating a set of one or more social interactions to the social networking exchange. These social interactions further comprise one or more of an opinion relative to a social event or an audio file preference; an information set containing reviews, comments, links, etc., and a link to a music playlist.

The social interaction aspect of the system comprises one or more entry portals. The portals are the enabled devices that allow access to the social networking routines of the system. Users of the system automatically accumulate (earn) levels of classification by the system based solely on their activity with their music/video files including plays, downloads, sharing and referring to others The users are assigned a social classification that allows participation in the social networking exchange in accordance with predetermined parameters established for each social classification. The system user enters the exchange through one of the portals and interacts in accordance with their social level. For instance, basic users can disseminate opinions and information relative to a particular topic, as well as to link other Users to their playlists and other relevant content sources. The next step up from Basic User is “Guru” status. The various levels of Guru status are achieved by the volume of user to user postings, recruiting new members, making music recommendations, etc. The higher the social status of the user, the more likely it is that they will be used as a relational reference and thus the more points acquired to determine their social level.

The above, and other aspects, features and advantages of the present invention will become apparent from the following description read in conduction with the accompanying drawings, in which like reference numerals designate the same elements.

### BRIEF DESCRIPTION OF THE DRAWINGS

FIG. 1 is a high level pictorial schematic depicting the system of the present invention.

FIG. 2 is a high level timing diagram of the system's user and device registration steps of the present invention.

FIG. 3 is diagram of the BEYOND business and technical system components.

FIG. 4 is a diagram of the system server topology.

FIG. 5 is a flowchart of the formatting steps for the media file with embedded license.

FIG. 6 is a flowchart of the method of the present invention wherein song tracks are identified for systemization and inclusion within the system-wide library.

FIG. 7 is a flowchart of the systemization process associated with individual music tracks.

FIG. 8A is a flowchart of the entry into the application from the digital audio/video enabled device.

FIG. 8B is a continuation of the flowchart of FIG. 8A and more particularly of the steps utilized in searching within the rich internet application.

FIG. 8C is a continuation of the flowcharts of FIG. 8A and FIG. 8B, and more particularly of the steps utilized in searching within the molecular relational application.

FIG. 9 is a diagram of the input parameters for establishing the Guru levels within the social networking system of the present invention.

FIG. 10 is a flowchart of the Partner-Client Management Registration for the Partner User and Partner Manager application entries.

FIG. 11 is a relational diagram of a tabbed homepage for use in the system of the present invention.

FIG. 12 is a relational diagram of the partner gateway to the system of the present invention.

FIG. 13 is a relational diagram of the end-user devices and their inter-operation with the system.

FIG. 14 is a pictorial of a typical digital audio/video enabled device for use as a node in the present invention.

FIG. 15 is a flowchart of the method flow for system content ingestion showing the track sourcing via internet through system ingestion servers and through to license encoding and embedding.

FIG. 16 is a flowchart of the royalty payment calculation and payment methodology.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

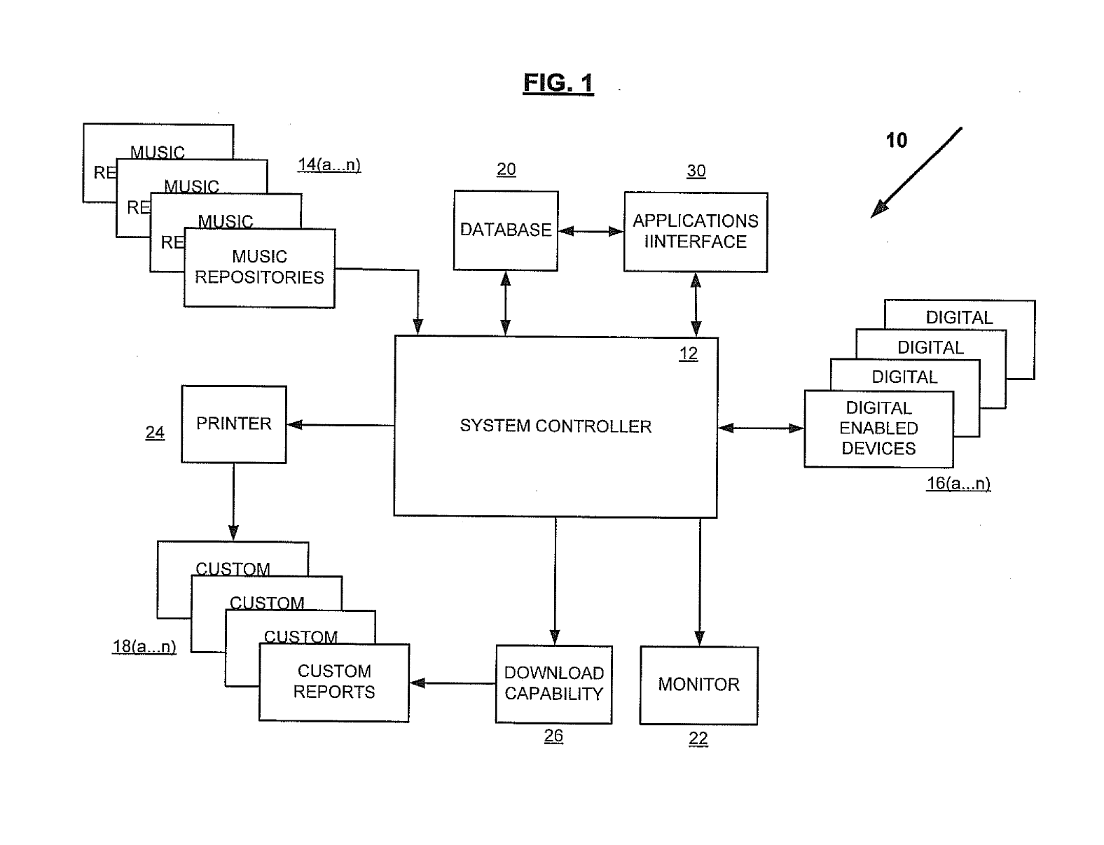

Turning to FIG. 1, there is shown a high level flowchart of the overall system of the subject invention which is designated system 10. System 10 comprises a central hub in the form of an interoperative system controller 12 which can be a computer or similar data processing system for processing data derived from transactions between system users as well as for processing the flow from one or more databases 20 supporting the system 10. System controller 12 has a number of input and output points which allow connected devices located at the input and output points to utilize the subject invention. It will be recognized that system controller 12 is representative of single or multiple communication and processing networks capable of providing interoperative services via the Internet and accessible by multiple parties for multiple purposes.

Digitally enabled devices 16(a . . . n) are any of the audio or video or audio/video digitally enabled devices such as MP3 players, cell phones, GPS systems, portable computing devices, game consoles, digital cameras, and personal computers or others known in the consumer electronics industry (noted as MEM's above). These devices interface with system controller 12 and form the user interface between the system and the device users. Additionally, it is contemplated that the manufacturers of these devices will be licensed by the system administrators so that each licensed device generates a system identification (ID) that is read by the system so that a user in the market place, can access the system for digital audio or video files without paying a royalty each time (e.g., the MEM device is pre--licensed). Thus, a license is granted to a device 16 which allows the device 16 to participate in the downloading and exchange of audio/video files. Individual payments to stakeholders, such as the copyright holder or recording artist, are based solely upon the use of the digital audio/video files on a licensed enabled device by the end user; and, the charge per play is paid by the system, and not by the device. As device users utilize devices 16 to download audio/video files, the request for a download causes repositories 14(a . . . n) to be accessed for the file. Upon access, the system controller 12 records the transaction of plays per file per user and stores the relevant data in database 20. In an embodiment of the invention, the data to be captured will include a record of plays and the file to be downloaded as well as any demographic data concerning the purchaser or file type. So in addition to performing an accounting function so as to generate payment data, demographic or frequency data can be generated as well for custom reporting 18(a . . . n).

Custom reports 18(a . . . n) can be generated by printer 24, or as a download 26 to a networked or web client, in specific formats that satisfy requirements of the end-user. These reports (for instance, an account of all plays) can be generated as a profit center for industry consumption to reflect music choices, number of plays per file, frequency of download, demographics, and correlations in social networking that reflect opinion or similar data. In addition to printing reports, the system controller can utilize monitor 22 to view reports as required.

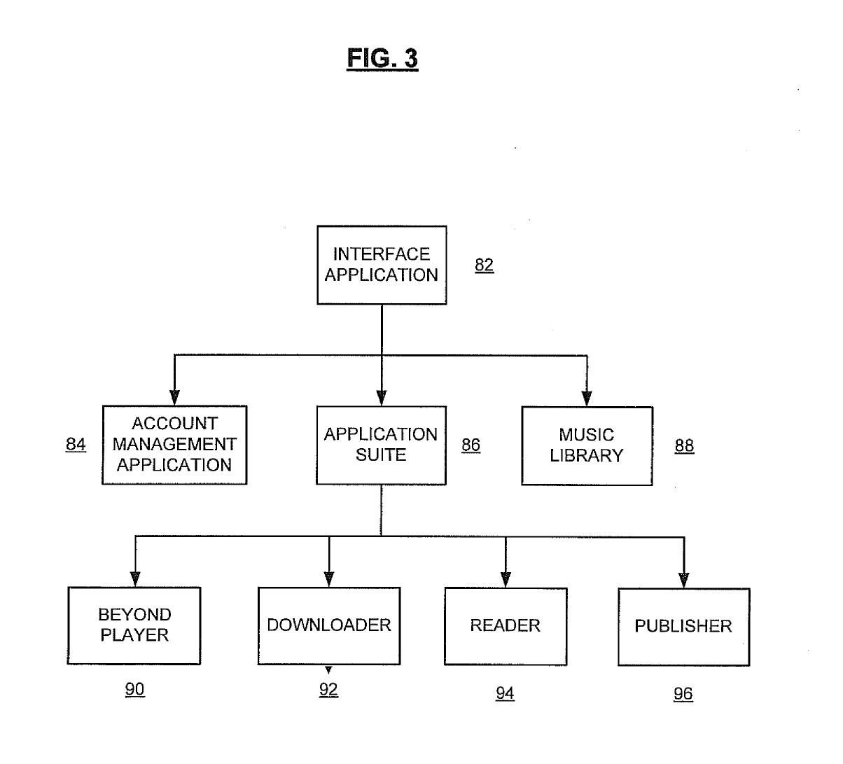

Applications interface 30 links the system user with the three primary business and technical system components that are further depicted in, and further described with relation to, FIG. 3. Interface 30 is interoperably connected with database 20 to both draw and transmit stored data, and with system controller 12 which supplies the operational backbone.

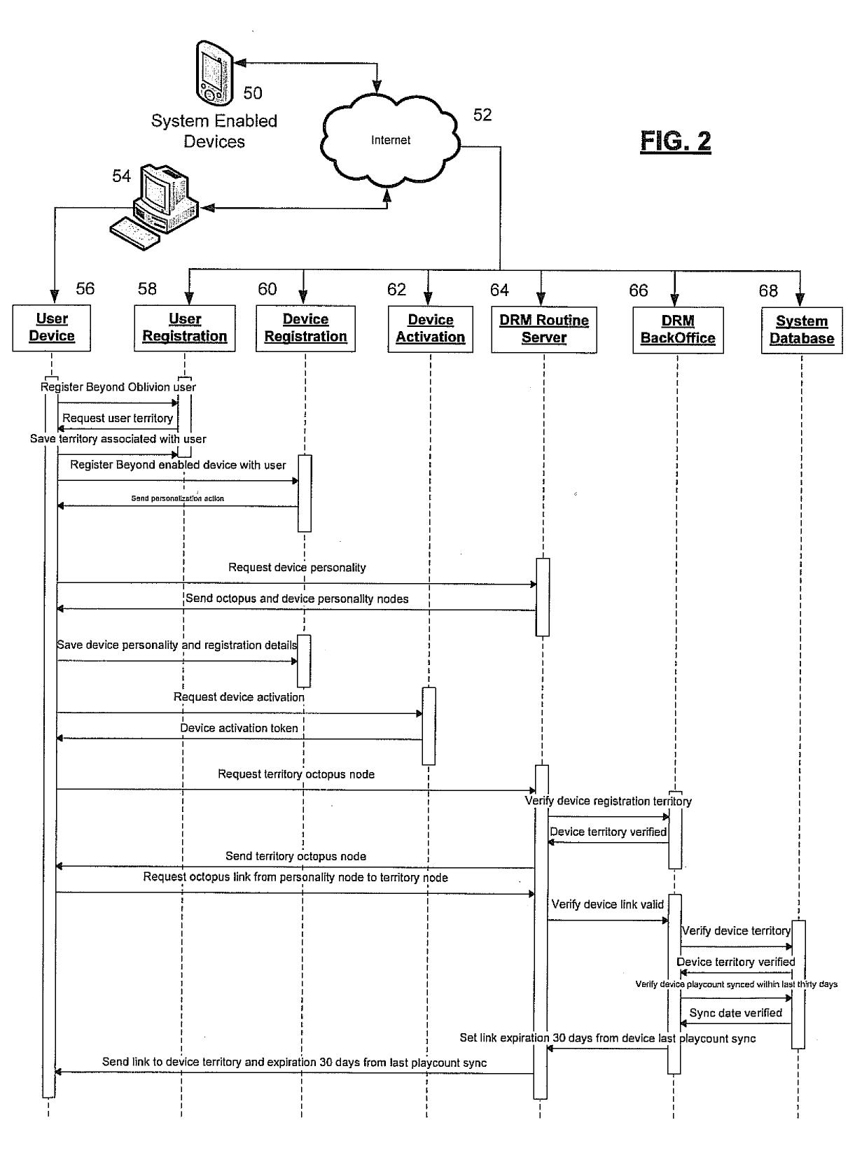

Turning then to FIG. 2, there is shown a high level timing diagram of the system 10 user and device registration steps of the present invention.

When playing a system enabled device 50, the initiation uplink back through internet cloud 52 triggers a system link at system data processor 54. The user device 56 is acknowledged by the system so that user registration 58 can be established. The system will prompt the user to register. The system will query device 50 as to its territory and save the response so as to allow device registration 60 to begin. The “personality” of the device 50 (that is, its licensed configuration) will be exchanged with the system 54 and the digital rights management (“DRM”) server will be triggered to send device personality characteristics. The personality and registration details will be saved as part of the device registration 60.

After exchange of the personality details, device activation is requested at by device activation step 62. A device activation token is generated by the system, which allows the device 50 to request its territory availability from the DRM server 64. The DRM routine server then verifies the device registration territory with the DRM back office service and database 66. The node for accessing the territory is sent to the device 50 which links the personality and territory parameters and is verified by the DRM backoffice 66. The device and the system sync their records and a sync date is verified with the database 68. The linking expiration date is reset (generally at 30 day intervals, though the timing is system discretionary) and a new access device expiration established.

Turning to FIG. 3, there is shown a diagram of three primary business and technical system components of the present invention and their interface 82 with system controller 12 as is shown in FIG. 1: the account management application 84; the application suite 86; and, the Music Library 88.

Features within or Interactive with the Website User Interface 82

(1) UI interface for allowing user to enable Facebook® application
(a) Add this to the wizard setup process for installing the proposed system.
(b) Allow user to opt in separately to showing their “what's playing” track in the timeline and the ability to publish playlists to friends.
(c) Allow user to input Facebook® username and password (show help icon which leads to message about what this feature is).

(2) List playlists and contents along with proposed system community profile
(a) On community profile page list playlists along with collapse/expand functionality to list contents of playlist.

3) Ability to publish the playlist to your friends on Facebook® site
(a) See a list of playlists you've chosen from within your player to publish along with your system profile.
(b) See Facebook® icon next to playlist name to indicate you want to publish playlist to Facebook®.
(c) Open modal dialog with list of Facebook® friends you can select to share with.
(d) Modal dialog allows you to enter a message to send to friends along with playlist.

(4) Ability to accept playlists of friends that have been shared with you
(a) Message from friend shows up in message section in right column in browser, and in left column in player.
(b) Message contains an “Accept” button, which adds the playlist to your community profile page along with additional indicator showing the friend's name it was received from.
(c) Using javascript Player API, friend's playlist is added to player along with special Facebook® friend indicator.
(d) Playlistsongs being shared are added to download queue in player

The application suite 86 comprises four routines; these are: the Beyond Player 90; the Downloader 92; the Reader 94; and, the Publisher 96.

The Beyond Reader 94 is a standalone application that can be plugged into the Beyond Player 90 and other components of the Beyond suite of applications. The Reader connects (invisibly to the user) with the Beyond Database 20 to provide an accurate and verifiable record of plays from all players on Beyond licensed MEMs, including but not limited to iTunes. The Beyond Reader 94 will connect the Beyond enabled MEMs to the Beyond Database through the Internet, either directly from a PC, or indirectly (side loaded) through a Beyond enabled computer, or from a smart MEM with direct—possibly wireless-access to the Internet (a game system, a mobile phone, etc.).

Features within or Interactive with the Player 90

(1) Ability to create and add songs to a playlist

(2) Ability to push playlist definition up to a user profile
(a) Limit playlist length to a reasonable number of tracks, for example 150 tracks but not limited thereto in a manner that balances between useability and featurability.
(b) Limit only to ‘system’ type tracks in the user's library—by definition this also means that the track is found in the online library.
(c) Serialize and send only an array containing the playlist name and the unique IDs of the track titles in the playlist.
(d) Server responds with the acknowledgement of the received playlist, validated playlist length, and the corresponding ID of the new playlist created.
(e) For now omit functionality related to keeping a changing playlist in sync with the playlist stored on the online system servers.
(f) Upon aknowledgement of created playlist, add UI indicator to Player service pane next to playlist indicating it is synced online with online system.

(3) Ability to push what users is real-time listening to up to the user's social timeline on Facebook®
(a) Provide that data collected by the play-count reporting mechanism for each device is updated into the system database to record such push-actions.
(b) Maintain a feature to maintain the electronic link between the actual user and that user's unique play count data and also optionally collect this data with a separate mechanism in the form of an electronic database with operational software.
(c) Provide a schedule application to push (electronic notice) of “what's playing” track titles to the a user's Facebook® timeline.

The Beyond Reader 94 optionally does the following; monitors files from Beyond, iTunes, etc., and transmits the data back to the Beyond Database 20; feeds current track playback into a user's social profile on the Beyond Library 88 (or optionally performed by the publisher module of the player, without limitation thereto); captures ID3 Tag Info if needed (this references the metadata on each file to identify the track. Album Art for example is optional and not required, and without limitation thereto); references metadata database (to pull artwork, ID, etc.); links to social media APIs to publish current track info (or optionally as part of the publisher module, without limitation thereto); and, gets installed by Beyond Player 90 once Beyond Player 90 has been installed and licensed. The inclusion an operational discussion above does not restrict or require Beyond Reader 94 to every action in every embodiment.

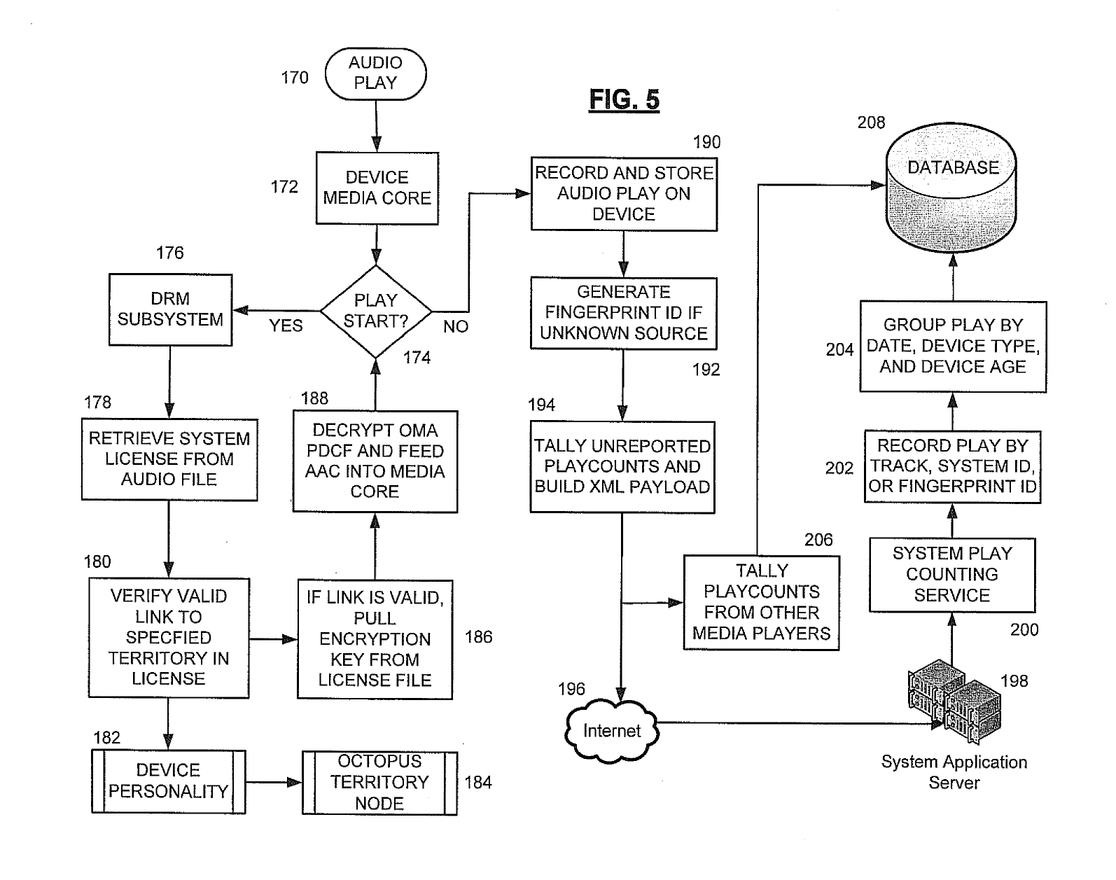

The combined Beyond Player 90, Downloader 92, and Publisher 96 functionality enables the following: music downloads; playback, FWD, RWD, FF, & Pause functions; playlist, full music library 98; custom playlist, and smart playlist access; file Management, such as “Suggest 2 A Friend, delete, copy, and create functionality; a sign-up helper menu; a device registration wizard; organization of a separate playlist and creation of a playlist based activity within a music collection; publishing of playlists and libraries to the Beyond Music Cloud (see FIG. 5) for improved library management across the user's devices; user library system adaptation; and side-loaded device management. Additional functionality comprises: Direct Beyond social interaction and extended social interaction with existing online communities, including Facebook, MySpace and Twitter; player add-ons (almost completely community sourced) that extend player capabilities in search, recommendation, sharing, and discovery; receiving and sending private messages; receiving and replying to targeted marketing from Beyond Partners, such as record and merchandising companies, but also consumer product companies seeking highly targeted and differentiated demographics.

The Beyond Player 90 Addon library 88 is a micro-site where Beyond users can come to download applications developed by various individuals and communities interested in enhancing the music discovery, listening, sharing, or Beyond Social experience. Such applications may be developed by the users' peers within the Beyond community, by the Beyond development team, or by third parties. Beyond provides developers with APIs to the Beyond recommendation, search, and social engines. It also provides documentation and SDKs, and encourages anyone to put their own creative spin on music. The Beyond Player Addon Library 88 may also be developed to serve as a marketplace for developers in the community to monetize their efforts and creativity. In this scenario, developers would be allowed to advertise their addons, as well as set a market price.

The Beyond Playlist Publisher 96 feature is key to the overall Beyond music experience. Publishing a playlist in effect takes the playlists users create, and listen to on any of their Beyond MEMs, and allows users to quickly publish metadata that defines those playlists up to the “Beyond Music Cloud”, which, in turn, results in various other enhancements to the user. The Beyond Music Cloud allows users to remotely manage the content of those playlists, share those playlists with friends in the Beyond community or other social communities (like Facebook, MySpace, and Twitter), or manage what automatically gets synced onto the other Beyond-licensed MEMs users may own. In the end, the Beyond Music Cloud is an extension of the user's profile, and allows another dimension of sociality between members, as well as serving as a tool for playlist management across devices the user may own.

The Beyond Infinite Music Library 88 functions as a “search tool” accessible by any network-connected MEM, either directly or indirectly (i.e., side-loaded). It enables: permanent download of digital music files and Beyond software; search and discovery of artists and repertoire through various relational search and recommendation navigation methods; and, sharing, referring, recommending, and publishing of playlists, and opting in for partner incentive rewards of the Beyond Social network. Any user can search for music, download, share, and interact socially in the Beyond community so long as they have gone through the free account creation process, but only consumers with a registered Beyond-licensed MEM can play full-length music from Beyond. Users search for Beyond Infinite Music Library 88 digital music files through intelligent relational search, recommendation and sort methods. When a user initiates any search (i.e., by artist, genre, song, album) a page will populate with results that are directly related to the search subject: songs with the same title or by similar artists, other songs by that artist, or top fan (“Guru”) playlists for referrals from users with similar tastes. Users can then choose a path to follow by clicking on any of the results to find more music. The user has two search interface options: the more familiar List View Interface, or the unique Molecular Search Interface, the web 2.0 UI, and the key UT to be ported to mobile and handheld MEMs. Users can easily toggle between the two views of the results. The Infinite Music Library 88 has two homepages. The default homepage, for users who have not yet created accounts in the system, features an intelligent search field (Basic & Advanced) to get the User started. The second homepage, for users with accounts, shows a search field that is presorted according to the preferences entered during account registration. The presorted page will default into the Molecular Search Interface, which can easily be toggled to the List View Interface for more results.

Features within or Interactive with the Proposed System and External or Linked Facebook® Application

Display a user's specific playlists.
Present user options on how to display the linked Facebook® Application (for example in a sidebar box view or in a main area larger view with tabs).
Allow a user to designate an ideal view of the display.
Display playlists with expand/collapse options.
Provide and program electronic version of carousel to either swap between different designated playlists (because individual tracks don't have artwork) or to swap between different tracks in a single playlist (showing album artwork for track as image).
Identify visually, below carousel list, upcoming track titles.
Display identified or designated friends playlists with special designator (consistent with view in the initially provided system interface).
Feature to detect if browser is equipped with system (‘Beyond’)/Marlin DRM plug-in and has assigned NEMO personality node matching an ID in the Beyond system (indicator that the device is registered for the claimed system).
Feature to play streaming content (stream MP3 no encryption, no DRM.
Feature to allow non-system ‘Non Beyond’) users get to play 30-second clips with a visual image, to encourage prompting the user to upgrade to becoming a full system user.
Feature allowing clicking on visual nag to become system member sends user to special landing page for system users.

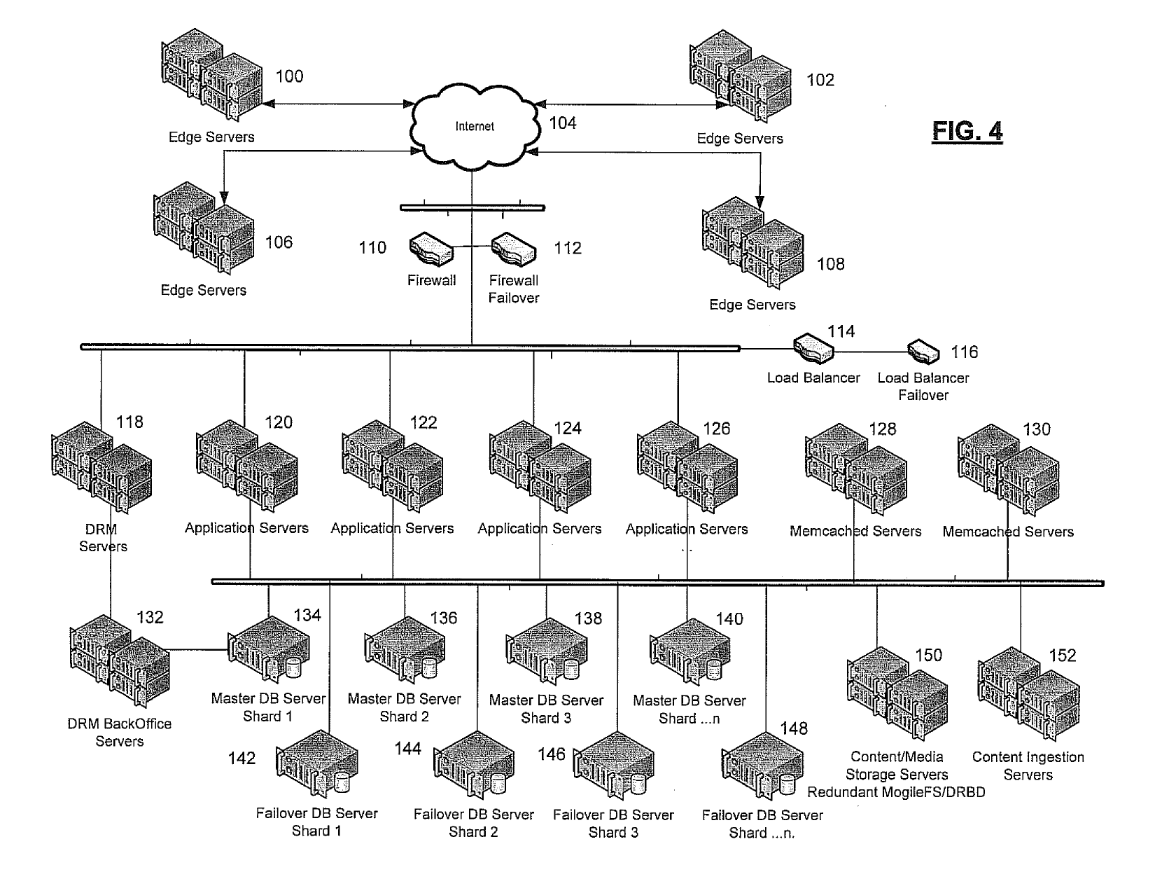

Turning to FIG. 4, there is shown a diagram of the system server topology.

Edge servers 100, 102, 106 and 108 handle the flow of data that is passed via the internet 104. A redundant firewall protection is afforded to the Beyond system by firewall applications 110 and 112, while redundant load balancers 114 and 116 provide a balance of data loading to the system servers by optimizing data load routing amongst the system servers.

The system itself utilizes multiple servers to balance loading as well as to provide efficiency within certain data groupings and specific applications. By way of exemplary distribution only, server 118 handles DRM activities; servers 120, 122, 124 and 126 handle various system applications while servers 128 and 130 handle memory caching in support of the applications.

DRM server 118 is linked to at least one DRM backoffice server which, in turn, is linked to a master database server shard 134. Additional master database server shards 136, 138 and 140 are linked with the application and cache servers with respective redundant database server shards 142, 144, 146 and 148. Content media storage servers 150 and content ingestion servers 152 are linked as well.

Turning to FIG. 5 there is shown a flowchart of the formatting steps for the media file with embedded license.

An audio play is selected at step 170 which allows access to the device media core 172. From the access point, the system flows to the query at step 174 which queries as to whether or not a track play is to be started. If the response to the query is “YES”, then the flow advances to a link with the digital rights management (“DRM”) subsystem. The flow moves from the DRM link to to retrieve the embedded system license from the audio file at step 178. That there is a valid territory link in the license is verified at step 180 and the device personality is defined at step 182 before the octopus territory node is activated at step 184.

Returning to step 180, once verification of the territory link has taken place, the flow advances to step 186 where the encryption is pulled from the license file. The data formats are decrypted into the media core at step 188 which returns the flow to the query at step 174.

If the response to the query at step 174 was “NO”, then the audio play is recorded and stored on the device at step 190 before the flow advances to step 192. At step 192, a fingerprint ID is generated if the track source is unknown. Unreported playcounts are tallied at step 194 and an XML payload of such data is built up. From step 194, the flow diverges over parallel tracks. Track one advances to step 206 where the playcounts are tallied from each media player and then stored database 208. Track two links, via internet 196 with the system application server 198. The system flows to the system play counting service at step 200 before recording individual plays by track name, system ID, or fingerprint ID. The individual results are grouped at step 204 by date, device type and device age before being stored at the database 208.

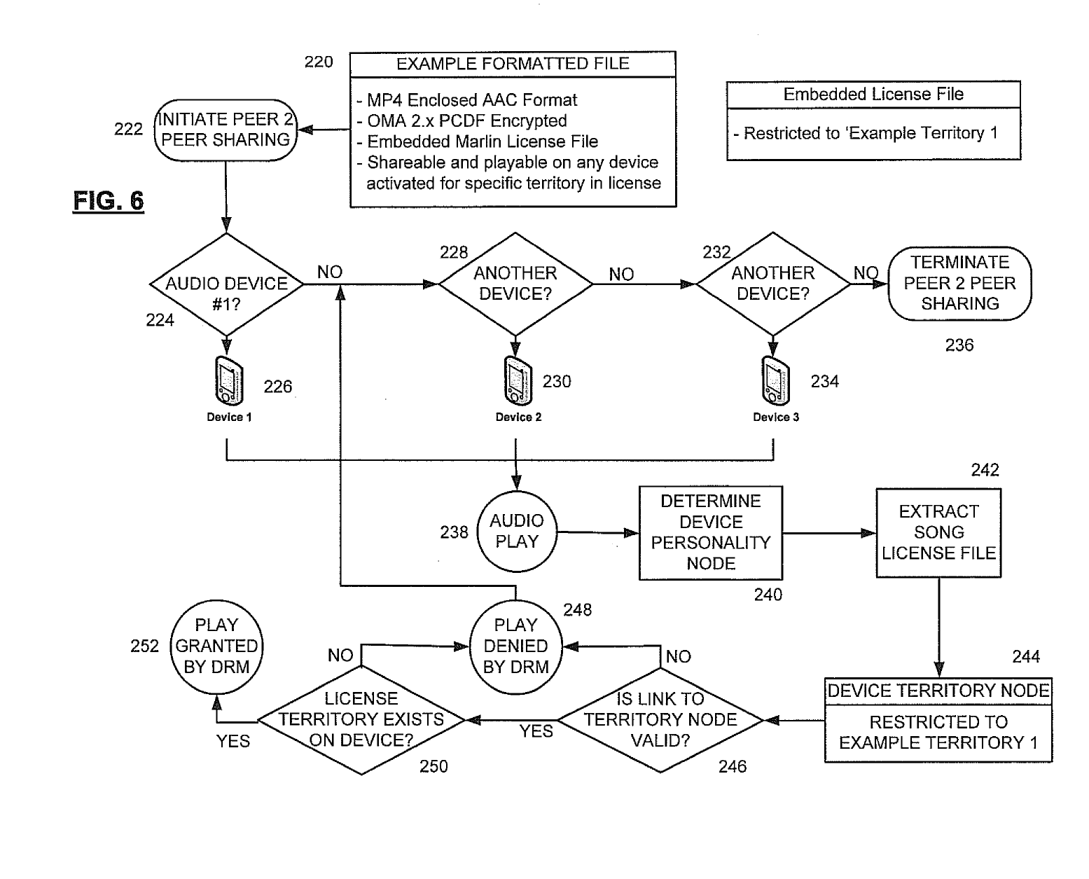

Turning to FIG. 6 there is shown a flowchart of the method of the present invention wherein song tracks are identified for systemization and inclusion within the system-wide library.

An example of an encrypted formatted file 220, with MP4 enclosed AAC format and an embedded license file of a type generated by the commercially available Marlin DRM system, and shareable and playable on any device activated for a specific territory as defined by the license is shown entering a peer-2-peer (“P2P”) sharing sequence step 222. From step 222, the flow advances to a query at step 224 which asks if a particular audio device 226 is to be utilized. If the response to the query is “YES”, then the flow advances to step 238 where the audio play verification is initiated before advancing to step 240 to determine the device personality mode. From step 240, the individual track's license file is extracted at step 242 before activating the device territory node at step 244. From step 244, the flow advances to the query at step 246 which asks if the link to the territory node is valid. If the response to the query at step 246 is “NO,” then the track play is denied at step 248 before advancing back to the system flow in front of the query at step 228. However, if the response to the query at step 246 is “YES”, then the flow advances to the query at step 250. At step 250, the system queries as to whether or not the licensed territory is compatible with the particular device. If the response to the query is “NO”, then the play is denied at step 248. If, however, the response to the query at step 250 is “YES”, then the play is granted at step 252.

Returning then to the query at step 224, if the response was “NO”, then the flow advances to the query at step 228 which asks if there is another device 230 to be used. If the response is “YES”, then the flow advances to step 238 as previously detailed. If the response to the query at step 228 is “NO”, however, then the flow advances to the query at step 232 which asks if there is another device 234 to be used, If the response is “YES”, then the flow advances to step 238 as previously detailed. If the response to the query at step 232 is “NO”, then the peer-2-peer sharing is terminated at step 236.

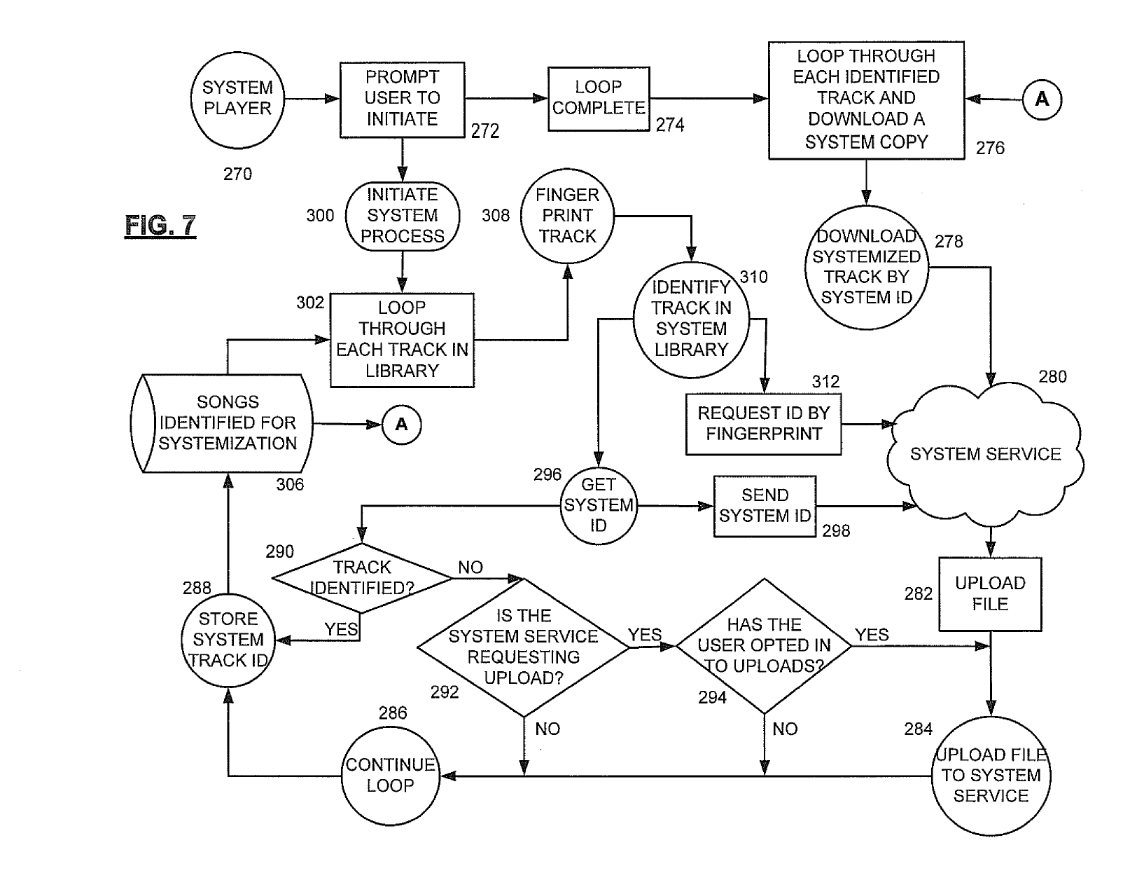

The user's machine undergoes a process that allows them to organize and play their exiting library in the system's Player application 90. FIG. 7 is a flowchart of the systemization process associated with individual music tracks of their existing library.

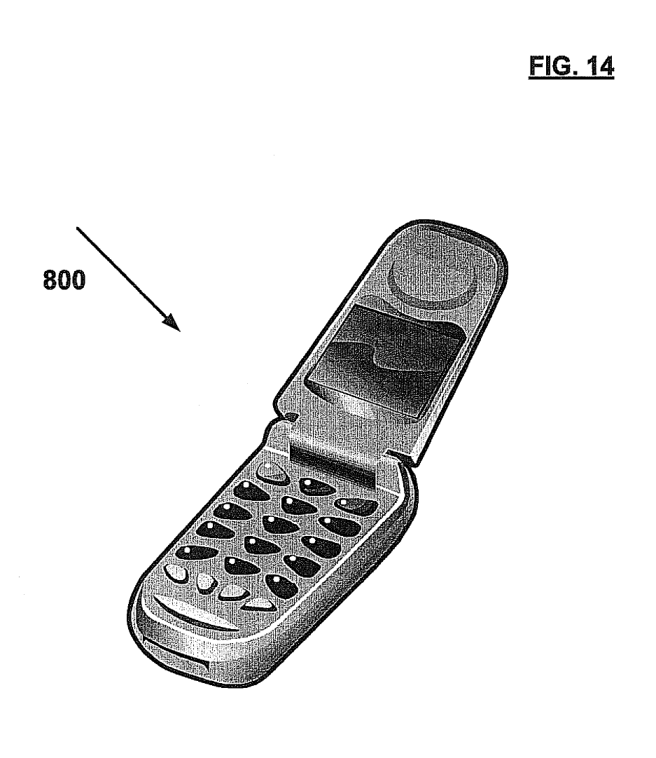

When a subsystem 800, or similar device type user (see FIG. 14) downloads and installs a client side application (such as the Beyond Player) to manage their library and play Beyond DRM content on their MEM device or other subsystem, the Player can import their existing library of music from their computer.

The library can be systemized so as to get the benefits of the system. In the present invention the process by which this occurs is referred to as “Beyondization”. The benefits of Beyondizing the library are to obtain high quality/high bit rate licensed copies for the user's existing library. These files will then include metadata with respect to track and album information that will be integrated directly with pre-existing label supplied content. Most content that is downloaded from peer-to-peer networks is pirated or degraded and can come in many different file formats. Most of these are very low quality, and the metadata is corrupted or inaccurate. If the user chooses to Beyondize their library, the process will not delete any of the their exiting files, but will download a “corrected” copy from the system.

The process begins with selected access through the system Player module at step 270. From step 270, the system advances to a user initiation prompt. The user selects the prompt and either advances to step 274 if no new audio tracks have been identified, or initiates a loop process at step 300.

At step 274, a check is made to determine if the loop has been completed, if so, then the system loops through each identified track and requests download of a system copy. The system advances to step 278 where the download of a Beyondized track is made by a subsystem ID. The result is recorded by the overall system service at step 280.

If a new loop was initiated at step 300, the system will loop through each track in the system library at step 302 before fingerprinting the track at step 308. Fingerprinting allows the system to identify the characteristics of a particular track so that it can be matched up with the corresponding track in the system library at step 310. If the track is “new” to the library, then the system requests that the track be identified by its fingerprint at step 312 before being registered by the system service at step 280. However, if the track fingerprint matches a track in the system library at step 310, then the unique system ID for the track is requested at step 296, and applied at step 298 before being registered by the system service at step 280. Additionally, at step 296, the system initiates a parallel path which advances to a query at step 290.

At step 290, the system queries as to whether or not the track has been identified. If the response to the query is “YES”, then the system advances to step 288 where the system track ID is stored. If, however, the response to the query at step 290 is “NO”, then the system advances to a query at step 292. At step 292, the system queries as to whether or not the system is requesting an upload of the audio track. If the response to the query is “NO”, then the system advances to re-enter the system flow at step 286. If the response to the query at step 292 is “YES”, then the system flow advances to the query at step 294 which asks if the user has “opted-in” to uploads via a selection available during initiation. If the response to the query is “NO”, then the system flow is re-directed to step 286. However, if the response to the query at step 294 is “YES”, then the flow is directed to step 284.

Returning to view the flow at step 280, we see that the system uploads the file at step 282, transports it to the database via step 284, and continues to loop through the track at step 286, before the ID and track are stored at step 288. From step 288, the system advances to step 306. At step 306, tracks are identified for “Beyondization” before traveling along path A to re-enter the system flow at step 276. In parallel, the system advances from step 306 to step 302 where the continued loop of each track continues until the system user opts out of the process at any point.

Features within or Interactive with the System and External or Linked Facebook® Application

(1) Display a user's specific playlists.
(a) Present user options on how to display the linked Facebook® Application (for example in a sidebar box view or in a main area larger view with tabs).
(b) Allow a user to designate an ideal view of the display.
(c) Display playlists with expand/collapse options.
(d) Provide and program electronic version of carousel to either swap between different designated playlists (because individual tracks don't have artwork) or to swap between different tracks in a single playlist (showing album artwork for track as image).
(e) Identify visually, below carousel list, upcoming track titles.
(f) Display identified or designated friends playlists with special designator (consistent with view in the initially provided system interface).
(g) Feature to detect if browser is equipped with system (‘Beyond’)/Marlin DRM plug-in and has assigned NEMO personality node matching an ID in the Beyond system (indicator that the device is registered for the claimed system).
(h) Feature to play streaming content (stream MP3—no encryption, no DRM.
(i) Feature to allow non-system (‘Non Beyond’) users get to play 30-second clips with a visual image, to encourage prompting the user to upgrade to becoming a full system user.
(j) Feature allowing clicking on visual nag to become system member sends user to special landing page for system users.

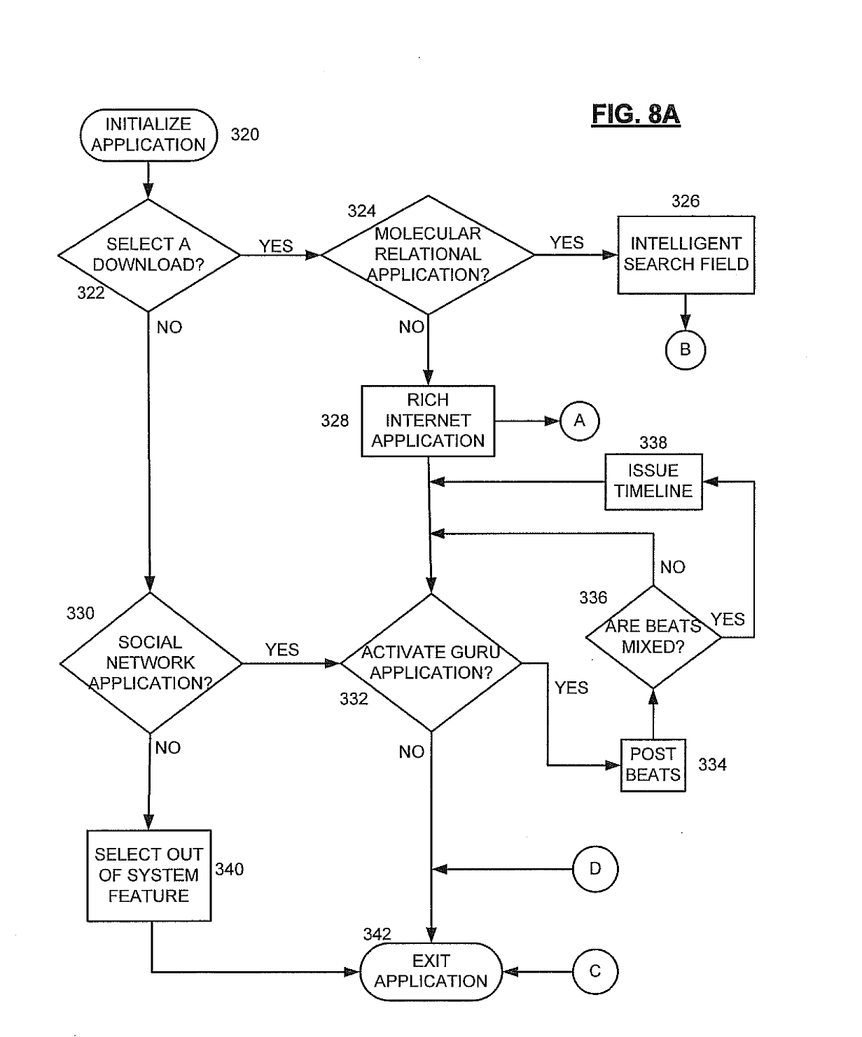

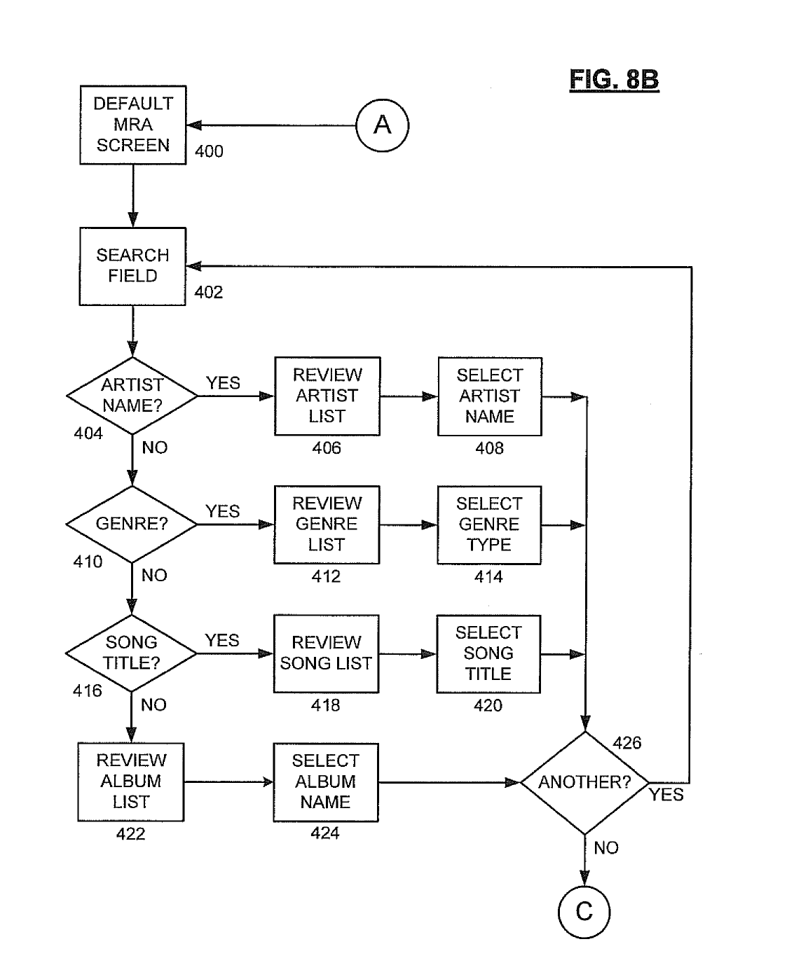

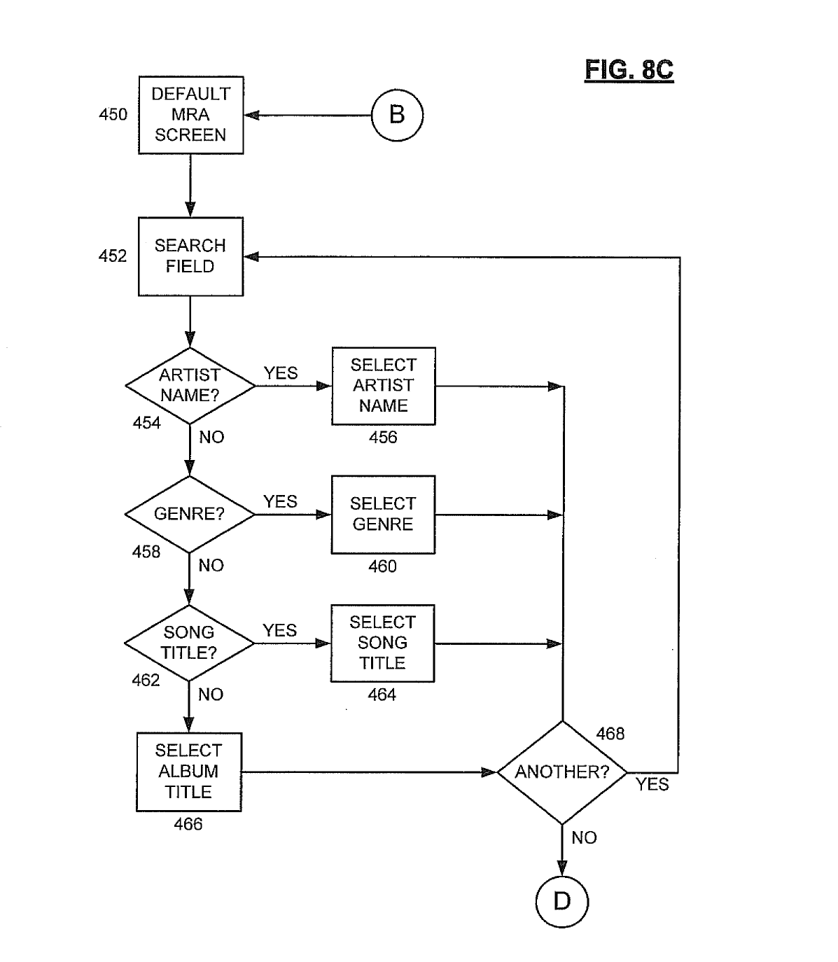

Turning to FIG. 8A, there is shown a flowchart of the steps for making a download selection. The application is initialized at step 320 before advancing to a query at step 322. At step 322, the query asks if the user wishes to select a download, if the answer is “NO” then the system advances to the query at step 330. If however, the response to the query at step 322 is “YES”, then the flow advances to the query at step 324 which asks if the molecular relational application is to be employed. If the answer to the query is “NO”, then the system advances to step 328 and accesses the rich internet application. If, however, the response to the query at step 104 is “YES”, then the molecular relationship application (or “MRA”) is accessed at step 326 where the search field is employed.

The molecular relational application opens with a default screen that includes a search field and a key search field. The key search field having an album name tab, an artist name tab, a song name tab, and a genre tab Above the search field at the top of the screen are additional genre tabs, each having a sub-genre pull down menu. Should the user decide to search utilizing this application, the search engine will predict correlating proper words, names, songs, or artists from the user's text entries until the correct, relevant subject word/name is shown or selected. On acceptance of the application's suggestion in answer to the search, the molecular screen application repopulates with sub-molecules that are tied to the central or system molecule depicted on the screen. As this application utilizes relational navigation, there are no web-pages; thus, the screen simply repopulates with new graphic depictions of appropriate search results. Search results are represented as molecules colored and sized to reflect their relational relevance to the search-term. To resort the orbiting molecules (orbiting about the large system molecule) by type, the device user clicks on the relevant index molecule at the bottom of the application screen.

After the search field is employed at step 326, the method follows along the path to point B where it re-enters the flow as shown in FIG. 8C.

Returning now to step 328, the rich internet application is selected. A rich internet application (or “RIA”) is a web application that mimics traditional desktop applications. Because RIAs utilize a client engine (that is, they typically transfer the processing necessary for the user interface to the web client) they offer richer capability by utilizing the client technology. Thus, at step 328, the user arrives at the default screen associated with the molecular relational application; but, if the user selects through the tab navigation (see FIG. 5) the “Music Store” capability, then the RIA will take the user to the traditional genre home page where the search results are organized and presented more traditionally as charts.

From step 328, the method advances along the flow path to point A where it re-enters the flow as shown in FIG. 8B.

Returning back to the query at step 330, the system asks if the user wishes to use the social networking site. If the response to the query is “NO”, then the method advances to step 340 where the user can select an out of system feature before exiting the application at step 342. However, if the response to the query at step 330 is “YES”, then the method advances to a query at step 332. At step 332, the system queries as to whether or not to activate Guru functionality. If the answer to the query is “NO”, then the flow advances to the application exit at step 342. If, however, the answer to the query at step 332 is “YES”, then the method advances to step 334 where beats are posted.

Beats are short (140 characters) postings that can be made by users (lower on the social hierarchy) or gurus (higher on the social hierarchy) to disseminate opinion or information as well as to link other users to their playlists and other relevant content sources. Users can also aggregate content such as playlists and reviews in their timelines (strings of beats which serve as a proxy for web pages).

A rise in social status within the system's social hierarchy is achieved by accomplishing certain activities such as: composing beats and adding followers;

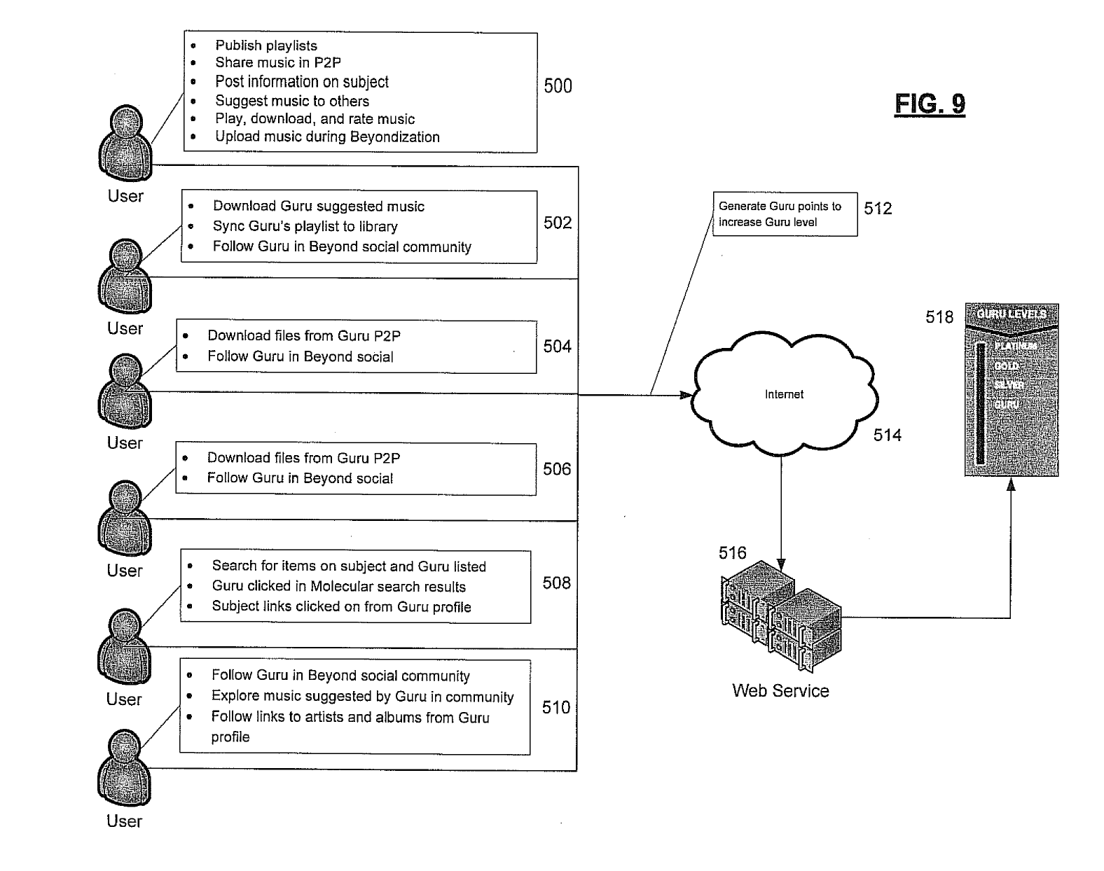

recruiting new users; suggesting music or other digital content files to friends or users; downloading files; or, receiving status points from other users. The higher the status of the user, the more likely it is that the user is used as a relational reference, and the more friends and influence acquired. Gurus, for instance, may o leverage their influence by opting-in to the marketplace application that aggregates gurus for the purpose of receiving targeted marketing of artists and songs. Gurus are further described in FIG. 9.

Returning to step 334, the flow advances to a query at step 336 which asks if beats have been posted to the system. If the response to the query is “NO” then the flow returns to enter in front of step 332. If the response to the query at step 336 is “YES”, then the flow advances to step 338 where the timeline is issued to the system user before returning to step 332.

Turning to FIG. 8B, there is shown a flowchart of the rich Internet application that flows in from path A to the default MRA screen at step 400. The user first arrives at the default MRA screen as described in detail with relation to FIG. 8A. At the MRA screen, the user makes the decision to utilize the Infinite Music Store capability through the tabbed navigation (instead of utilizing a pure search function), the RIA will take the user to a traditional (web page style) home page, where the results are organized and presented more traditionally as charts. The organization of the database and the relation of the results to the primary subject field are the same as with the MRA routine. The charts presented are in a style familiar to the user in that they utilize the music classifications of Billboard music news magazine and further broken down into genre type.

From step 400, the application employs the search field of step 402 which progresses to a series of queries beginning at step 404. At step 404, the system asks if the search is to be based on the artist name. If the response to the query is “NO”, then the flow advances to the query at step 410. If, however, the response to the query at step 404 is “YES”, then the flow advances to step 406 where the user reviews the list of artists that is available. The user makes the selection at step 408 before the flow advances to the query at step 426 which asks if another choice is to be made. If the response to the query is “YES”, then the flow returns to step 402 where a new search is initiated. However, if the response to the query at step 426 is “NO”, then the flow exits at point C to return to the flow at FIG. 8A where it proceeds to step 342 to exit the application.

Returning to step 410, the system asks if the search is to be based on the genre type. If the response to the query is “NO”, then the flow advances to the query at step 416. If, however, the response to the query at step 410 is “YES”, then the flow advances to step 412 where the user reviews the list of genre types that is available. The user makes the selection at step 414 before the flow advances to the query at step 426 which asks if another choice is to be made. If the response to the query is “YES”, then the flow returns to step 402 where a new search is initiated. However, if the response to the query at step 226 is “NO”, then the flow exits at point C to return to the flow at FIG. 8A where it proceeds to step 342 to exit the application.

Returning to step 416, the system asks if the search is to be based on the title of the song. If the response to the query is “NO”, then the flow advances to step 422. If, however, the response to the query at step 416 is “YES”, then the flow advances to step 418 where the user reviews the list of song titles that is available. The user makes the selection at step 420 before the flow advances to the query at step 426 which asks if another choice is to be made. If the response to the query is “YES”, then the flow returns to step 402 where a new search is initiated. However, if the response to the query at step 426 is “NO”, then the flow exits at point C to return to the flow at FIG. 3A where it proceeds to step 342 to exit the application.

Returning to step 422, the system initiates the search based on the album name, by presenting the list of available album names to the user. The user makes the selection at step 424 before the flow advances to the query at step 426 which asks if another choice is to be made. If the response to the query is “YES”, then the flow returns to step 402 where a new search is initiated. However, if the response to the query at step 426 is “NO”, then the flow exits at point C to return to the flow at FIG. 8A where it proceeds to step 342 to exit the application.

The queries at steps 404, 410 and 416 are representative of the choice of search and can be performed in any order.

Turning to FIG. 8C, there is shown a flowchart of the molecular relational application that flows in from path 13 to the default MRA screen at step 450. The user first arrives at the default MRA screen as described in detail with relation to FIG. 8A. From step 450, the application employs the search field of step 452 which progresses to a series of queries beginning at step 454. At step 454, the system asks if the search is to be based on the artist name. If the response to the query is “NO”, then the flow advances to the query at step 458. If, however, the response to the query at step 454 is “YES”, then the flow advances to step 456 where the user makes the selection from the relational molecules presented in the display field, before the flow advances to the query at step 468 which asks if another choice is to be made. If the response to the query is “YES”, then the flow returns to step 452 where a new search is initiated. However, if the response to the query at step 468 is “NO”, then the flow exits at point D to return to the flow at FIG. 8A where it proceeds to step 342 to exit the application.

Returning to step 458, the system asks if the search is to be based on the genre type. If the response to the query is “NO”, then the flow advances to the query at step 462. If, however, the response to the query at step 458 is “YES”, then the flow advances to step 460 where the user makes the genre selection from the relational molecules presented in the display field, before the flow advances to the query at step 468 which asks if another choice is to be made. If the response to the query is “YES”, then the flow returns to step 452 where a new search is initiated. However, if the response to the query at step 468 is “NO”, then the flow exits at point D to return to the flow at FIG, 8A where it proceeds to step 342 to exit the application.

Returning to step 462, the system asks if the search is to be based on the song title. If the response to the query is “NO”, then the flow advances to step 466 to select by album title. If, however, the response to the query at step 462 is “YES”, then the flow advances to step 464 where the user makes the song selection from the relational molecules presented in the display field, before the flow advances to the query at step 468 which asks if another choice is to be made, If the response to the query is “YES”, then the flow returns to step 452 where a new search is initiated. However, if the response to the query at step 468 is “NO”, then the flow exits at point D to return to the flow at FIG. 8A where it proceeds to step 342 to exit the application.

Returning to step 466, the user selects the album title from the relational molecules presented in the display field, before the flow advances to the query at step 468 which asks if another choice is to be made. If the response to the query at step 468 is “YES”, then the flow returns to step 452 where a new search is initiated. However, if the response to the query at step 468 is “NO”, then the flow exits at point D to return to the flow at FIG. 8A where it proceeds to step 342 to exit the application.

Already mentioned at various stages is the Guru status available at certain levels. FIG. 9 is a diagram of the input parameters for establishing the Guru levels within the social networking system of the present invention.

Gurus are the most active of registered users who opt in to earn points towards rewards or exclusive features or opportunities. Within the social networking community, gurus are considered as “experts” on certain subjects based upon their influence on other registered users. These subjects include: artists, genres, or songs, etc. The guru's influence is measured by how many other users subscribe to updates from the guru in the BEYOND social network, number of ratings submitted on a particular subject, and by downloading, playing, and sharing music with others.

Gurus earn points when they establish a community following, or when users download or queue tracks based upon the guru's recommendations. In return for earned points, Gurus receive special offers from artists, and system partners. Accumulated points promote the guru to different levels which are demarcated by gold, silver and platinum, though demarcation system could be used. The highest level gurus can then show up as molecules in the molecular search music discovery results. The more a guru shows up and the more their social profile is viewed, the more points they can accumulate toward their guru status levels. Once a guru achieves a certain status, they can then receive special offers such as concert tickets, VIP passes, special merchandise, and advance access to new music tracks.

Gurus can also opt-in to share content from the peer-2-peer (“P2P”) network during the Beyondization process. This allows the system cloud to locate and retrieve tracks that are frequently used, but not currently available in the system library. Any tracks found to be in high demand can then be pursued to obtain proper licensing for the file, and then make available a Beyondized version of the track for the social networking community through the system library.

In turning to FIG. 9, we are presented with the various elements that can be combined to propel a guru upward within the community. At block 500, the system user can: publish playlists; share music in P2P networking; post information on certain subjects; suggest music to others; play, download and rate music; and, upload music during Beyondization of individual tracks. As the system user gains in knowledge and experience, then the activities of block 502 become more prevalent. Here, the system user can download guru suggested music; sync a guru's playlist to the library; or, simply follow a particular guru within the social networking community. In block 504, the system user can download files from the guru's P2P group while continuing to follow a particular guru within the community; all the while accumulating points to increase their own guru level and availability to access files as seen in box 506.

In box 508, the system user can search for items based upon subject matter preference or by guru-listed preference. Additionally, they can follow the guru through molecular cloud selection or by subjects “clicked” on within the guru's profile. In box 510, the guru can continue to be followed within the community while the system user enjoys music suggested by the guru, or by linking to artists or track albums from the guru's profile.

The steps or events found in boxes 500 through 510 do not necessarily have to occur in order. The point building process can occur through an interplay of various boxes at various times. The events are delimited merely as an exemplary series. Each event generates points at step 512 which are recorded through the internet via web service interface at step 516. The accumulation of points is visually depicted at step 518.

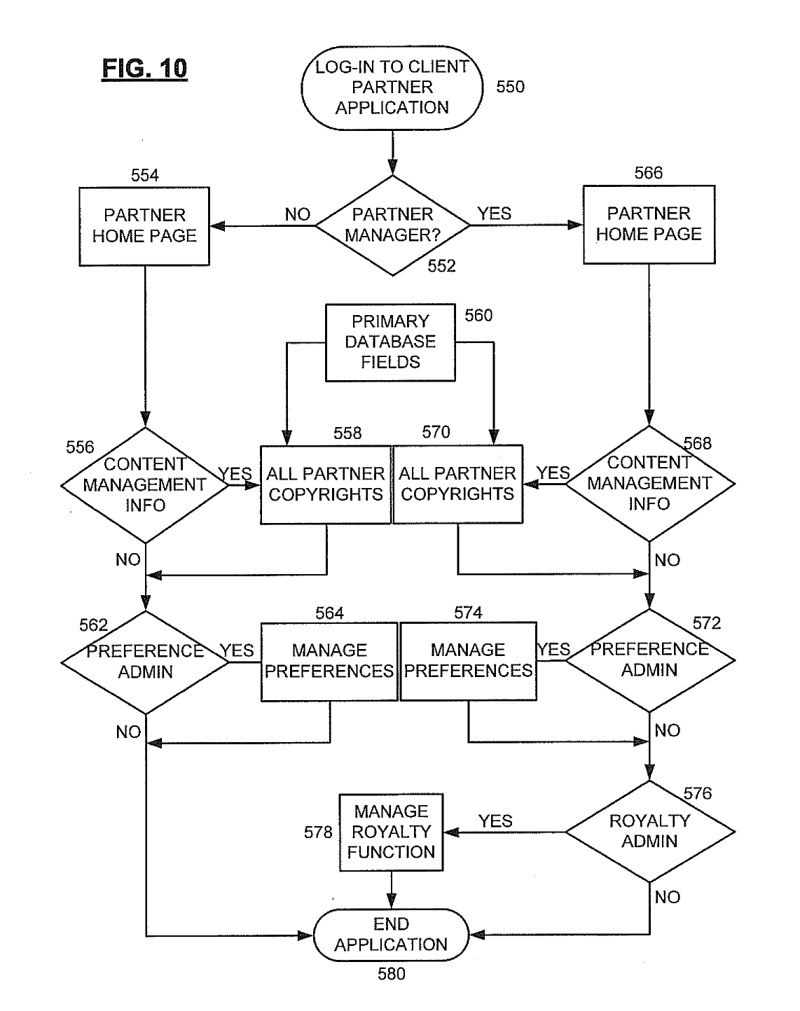

Turning now to FIG. 10, there is shown a flowchart of the client-partner management registration for the partner user and partner manager application entries.

The application begins with a log-in to the client-partner application at step 550. At the log-in, the flow advances to a query at step 552 which asks, based on the user's log-in credentials, if the system user is a manager level partner. If the response to the query is “NO”, then the flow advances to the partner home page where access will be limited based on the non-manager access level. If the response to the query at step 552 is “YES”, then the flow advances to the partner home page at step 556 where the user will have full access to the application features and can immediately access content management information.

From the partner home page, the flow poses a query at step 568 which asks if the partner wants to review content management info. If the response to the query is “NO”, then the flow advances to the query at step 572. If, however, the response to the query at step 568 is “YES”, then the flow advances to step 570 where all content management can be reviewed in terms of how it relates to all the partner's copyrights. The information is populated in the appropriate screen fields by polling the database at step 560. The primary fields of the database include, but are not limited to: the number of plays per music track or video; the number of downloads; the demographics related to system users; artist names; song titles; and album label names. For a specific song, album, artist, or record label the partner content manager can enter information into the page search engine; the results will list on the page below according to the search subject. From step 570, the system returns to the flow as it enters step 572.

At step 572, a query is posed that asks if the partner wants to manage their preference administration. These are the preferences that establish format and data selection. If the response to the query is “NO”, then the flow advances to the query at step 576. A “YES” response to the query at step 572 advances the user to step 574 where the individual preference parameters are entered before the system advances to re-enter the flow in from of step 576. At step 576, a query asks if the partner user wishes to engage in royalty administration. This step is only available to manager level partners and is not available to the basic user level. If the response to the query is “NO”, then the flow advances to step 580 where the application is exited. However, if the response to the query at step 576 is “YES”, then the flow advances to step 578 where the royalty functionality is accessed. The step contained recipient bank information and allows manipulation of royalty data, rates, distribution, and related administrative functions. From step 578, the system flow advances to step 580 where the application is exited.

Returning now to step 552, if the response to the query at step 552 is “NO”, then the flow advances to the partner home page at step 554 where the user will have limited access to the application features, but can nevertheless immediately access content management information.

From the partner home page, the flow poses a query at step 556 which asks if the partner wants to review content management info. If the response to the query is “NO”, then the flow advances to the query at step 562. If, however, the response to the query at step 556 is “YES”, then the flow advances to step 558 where all content management can be reviewed in terms of how it relates to all the partner's copyrights. The information is populated in the appropriate screen fields by polling the database at step 560. Here too, the primary fields of the database include, but are not limited to: the number of plays per music track or video; the number of downloads; the demographics related to system users; artist names; song titles; and album label names. For a specific song, album, artist, or record label the partner content manager can enter information into the page search engine; the results will list on the page below according to the search subject. From step 558, the system returns to the flow as it enters step 562,

At step 562, a query is posed that asks if the partner wants to manage their preference administration. These are the preferences that establish format and data selection. If the response to the query is “NO”, then the flow advances to step 580 where the application is ended. Non-manager partners do not have the opportunity to manage the royalty function; therefore, it is by-passed. A “YES” response to the query at step 562 advances the user to step 564 where the individual preference parameters are entered before the system advances to re-enter the flow in from of step 580 where the application is exited.

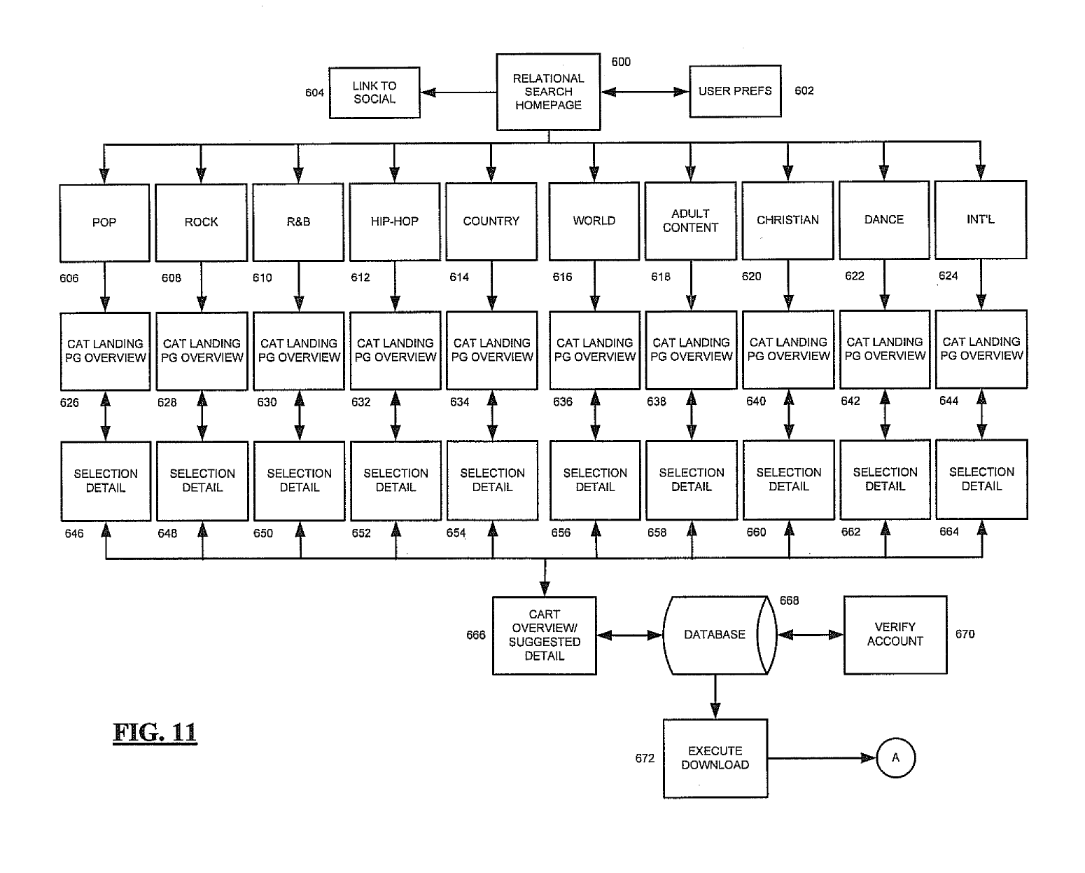

Turning next to FIG. 11, there is shown a relational search homepage for use when the rich internet application is selected. A rich internet application (or “RIA”) is a web application that mimics traditional desktop applications. Because RIAs utilize a client engine (that is, they typically transfer the processing necessary for the user interface to the web client) they offer richer capability by utilizing the client technology. Thus, at 600, the system displays the relational search homepage which interplays with the user preferences 602 and links, essentially simultaneously to the social networking portal at 604.

The relational search homepage 600 interfaces with categories 606 through 624 to facilitate the required search. In turn, each of categories 606 through 624 interfaces with its respective category landing page overview 626 through 644. The category landing page overviews are each capable of interchanging data with a respective selection detail 646 though 664. Selection detail elements further interface with the cart overview/suggested detail 666 which draws from the database 668. The ability of the system to draw from the database is handled by a check of the user device credentials to verify the account at 670. The system draws from the database 672 to execute the download to the end-user via path A.

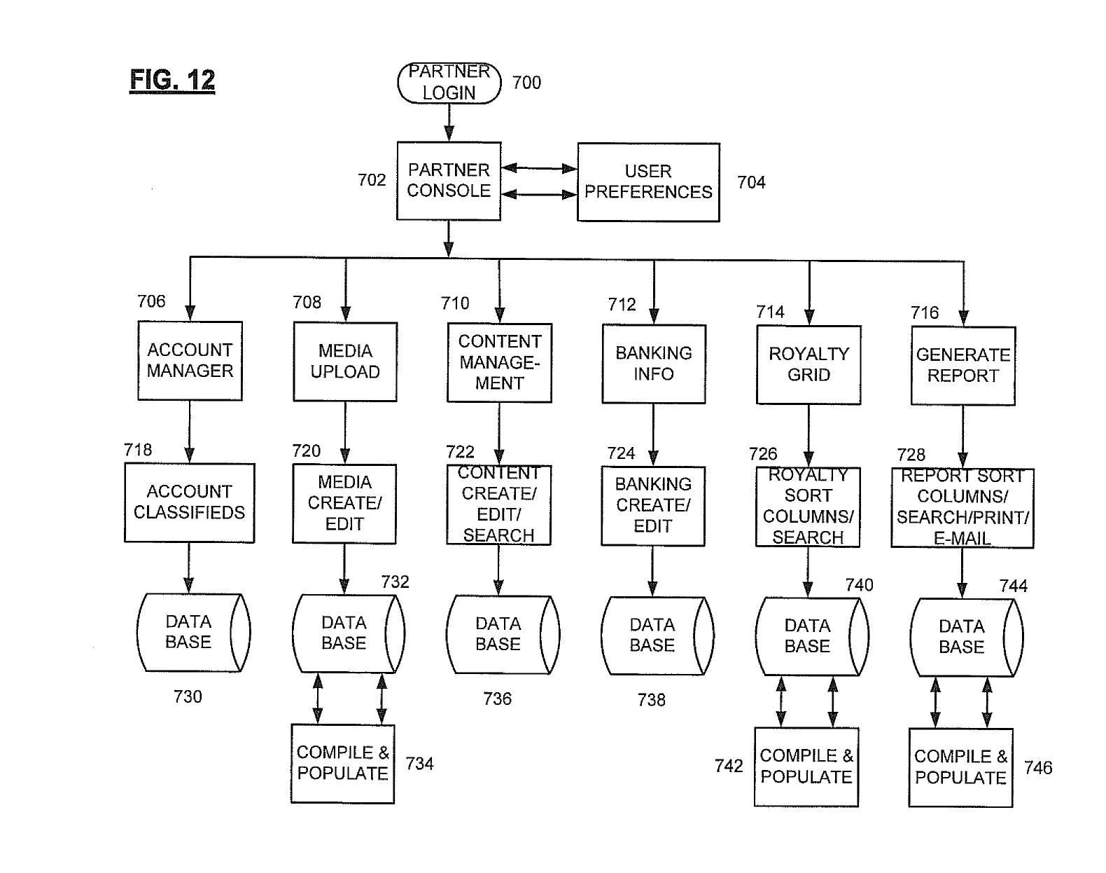

Turning to FIG. 12, there is shown the relational diagram for the partner gateway. The partner log-in at 700 allows the user to access the partner console 702 which interfaces with the user preferences 704 to allow the user to access: the account manager 706; media upload 708; content management 710; banking info 712; the royalty grid 714; and, to generate reports at 716.

The account manager 706 has a give/take interface with the account create/edit function 718 which draws off of database 730. The media upload feature 708 has a give/take interface with the media create/edit function 720 which draws off of database 732 which further interfaces with compile and populate functionality 734. The content management 710 functionality has a give/take interface with the content create/edit/search functionality 722 which draws off of database 736. The banking information 706 interface has a give/take interface with the bank's create/edit function 724 which draws off of database 738. The royalty grid 714 has a give/take interface with the royalty sort columns and search functionality 726 which draws off of database 740 which further interfaces with compile and populate functionality 742. The report generator 716 has a give/take interface with the report sort columns/search/print and e-mail functionality 728 which draws off of database 744 which further interfaces with compile and populate functionality 746.

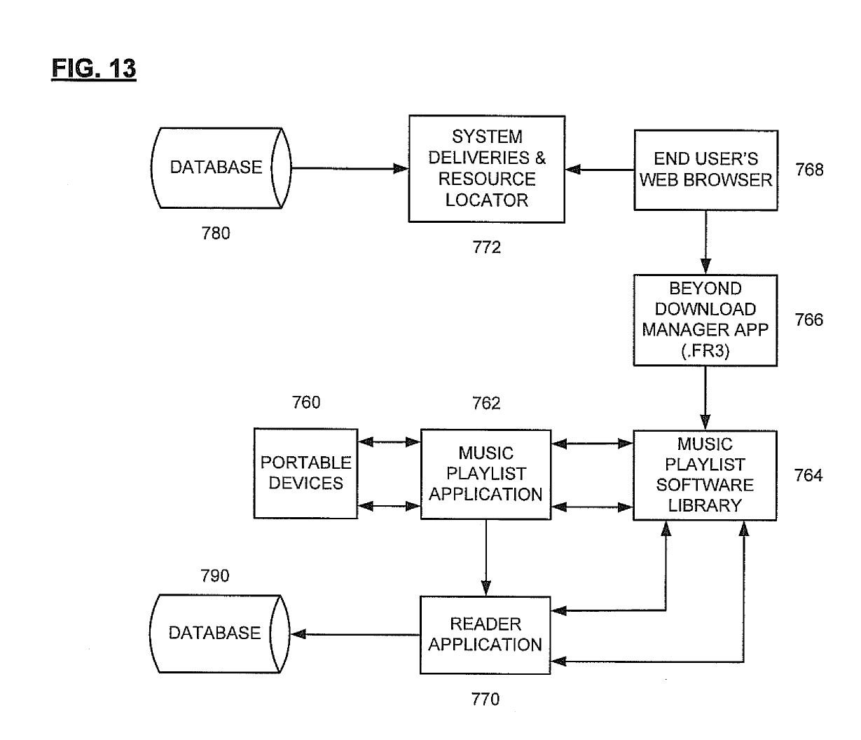

Turning next to FIG. 13, there is shown a relational diagram for the end-user devices of the present invention. The end-user's device 760 interfaces with the music playlist application 762. The playlist, in turn, interfaces with the reader application at 770 and the music playlist software library 764. The software library receives its download via the download manager application 766 resident in the user's web browser 768. The web browser draws its deliveries from database 780.

Returning to the software library 764, it further interfaces with reader application 770 which records the plays accounted for and sends these back to the database 790.

Turning to FIG. 14, there is shown subsystem 800, which is a typical cell phone capable of receiving a digital audio or video file as contemplated by the invention described herein; it is representative of all digitally compatible devices (MEMs) which can be enabled to receive audio or video files as long as the device is an internet enabled device; or, can connect to the internet by synching through an internet enabled device. Prior to selling the cell phone device, the manufacturer would purchase the appropriate license from the system administrators and activate the access routines embedded in the device. This will allow the device (post-purchase) to access the system and participate in both the download and social network applications, as well as to report on aggregate plays per file on the device. Thus, the invention shifts the responsibility for paying for music or video files from consumers to the manufacturers of digital devices who will pay the system license fees. Additionally, the system 10 allows for the payment of a micro-per-play royalty that is aggregated over a period of time. The aggregated royalties are then forwarded to the corresponding repository (much the way the industry giants ASCAP, BMI, SESAC and Harry Fox do now) so that copyright owners will receive payment for all relative plays.

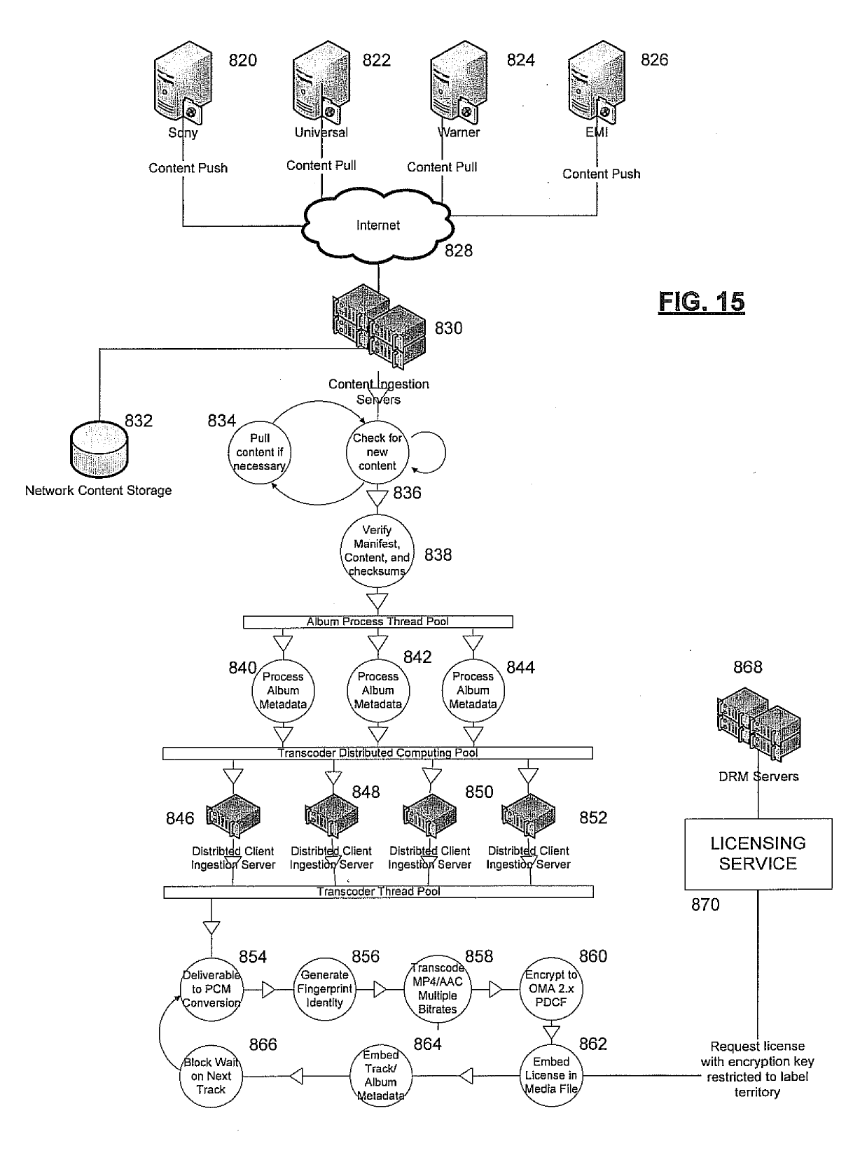

Turning then to FIG. 15 there is shown a flowchart of the method flow for system content ingestion showing the track sourcing via internet through system ingestion servers and through to license encoding and embedding.

At regular intervals, the system content ingestion process checks through the internet cloud 828 for new content drops from each of the system partners 820, 822, 824 and 826 which are exemplars of the partner community and can be in a position to push or pull content. In some cases the check will require that the process logs into a file transfer account on the Partner's server to check for file availability before being able to download the files from the respective server (a “pull” scenario 834). In other cases, drops will be uploaded to the ingestion servers 830 automatically by the partner's service (a “push” scenario).

Once a new drop is identified and in place, the ingestion service validates 836 the contents of the manifest file. The manifest file lists all of the files delivered with the content drop. Validating the manifest file includes checking the existence and validity 838 of each file listed in the manifest.

When the manifest has been validated, the ingestion will then locate the metadata (usually an XML file) for each album included in the drop. These albums are then passed on to an album processing thread pool. The threads will ingest the album metadata into the system database 840, 842, 844. The metadata will include items such as the album title, genre, release information, etc. 846, 848, 850 and 852. It will also create an artist record if the artist doesn't already exist within the system database. The threads will then loop through each track in the album, locate the track metadata, and place the location of the audio file along with the metadata in a pool for the ingestion distributed clients (a separate machine on the network) to pull work from. These clients will then offload 854 the bulk of the work (for speed and throughput improvement) by handling the fingerprinting 856, audio transcoding 858, encryption 860, license handling 862 receiving input from the DRM server 868 and processed through the licensing service 870, and track metadata ingestion 864 before removing the block on processing of the next track 866.

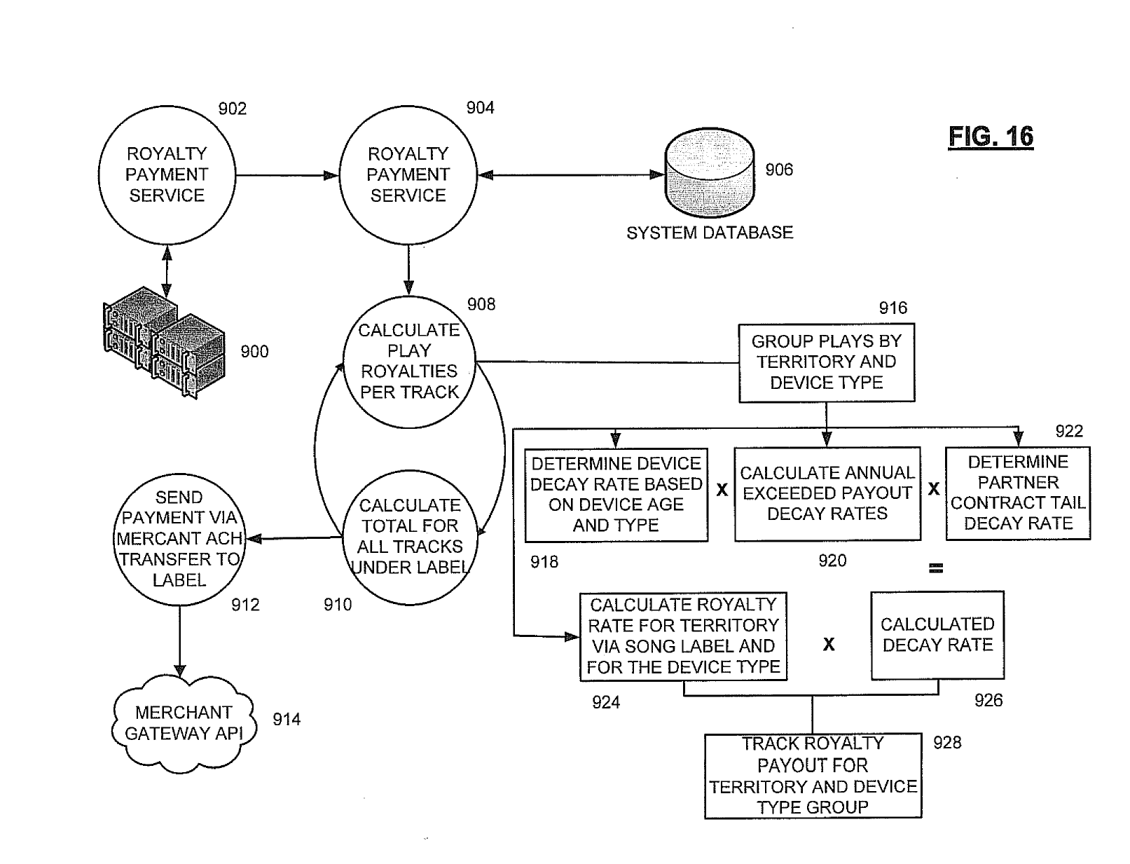

Turning to FIG. 16 there is shown a flowchart of the royalty payment calculation and payment methodology.

The method for gathering play count data for any given song track, so as to calculate royalties, is assumed to be grouped by the following criteria:
Data range—where the variable range for the data to be collected is established. A data user can be identified as well within this grouping.
Device type—where the device type (portable MP3, PC, home stereo, etc.) is identified.
Device Age—is determined by the number of months since the device was registered with the system service.
Region—is determined by a pre-selected geographic selection by state, general region (i.e., New England, Mid-Atlantic, etc.), or market.

The service is initiated at step 902 while drawing off the server at step 900. The service is active in step 904 and both draws data from, and stores data in, the database 906. From step 904, the system flow calculates play royalties per track at step 908 while interfacing with step 910 to calculate play totals and royalties for all tracks under a particular label. When all plays have been calculated, payment is sent via merchant ACH transfer to the individual label (record company) via a merchant gateway API.

Returning to step 908, the calculation of per play royalties is made by utilizing the calculation flow beginning at step 916. At step 916, group plays by territory and device type are determined by first determining the device decay rate, based upon device age and type, at step 918. The step 918 result is multiplied by the annual exceeded payout decay rates calculated at step 920; this total is multiplied by the partner contract tail decay rate. This, in turn, is multiplied by the royalty rate for a particular territory via song label and device type before being multiplied by the calculated decay rate. The result is tracked as a royalty payout by territory and device type.

The partner royalty rate is assumed to vary based on a given contract with each individual partner/label. It is assumed that each partner could negotiate different royalty rates based on device type, region, or volume metrics. The device age decay rate, on the other hand, is based on the amount of annual payout for the partner. Here too, it is assumed that each partner could negotiate a different decay rate based on annual payouts. The contract tail age decay rate is based on the on the amount of time since the partner contract has expired.

Those of skill in the art of interactive and transactionally linked electronic systems, having studied the above discussion in detail, will additionally recognize that additional improvements, features, and adaptations may be provided that build upon the foundation created herein. It is intended that these additional improvements, features, and adaptations are recognized as being within the scope and spirit of the present invention.

As will be understood by those of skill in the art having studied the enclosed full disclosure, the proposed systems, features, and improvements may be further modified and integrated for interoperability purposes without departing from the scope and spirit of the present invention.

In the claims, means, or step-plus-function clauses, are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1. A method for determining, within a data processing system, a royalty to be paid for use of a file, said method comprising the steps of:
(a) embedding license data within said file;
(b) initiating a scanning routine for scanning said file to determine a set of metrics for said file;
(c) allowing said file to be played by a device within a specified territory;
(d) maintaining a register of each instance that said file is played and aggregating a set of total instances;
(e) initiating a calculation routine within said data processing system for determining a royalty in respect of said metrics;
(f) determining said royalty by territory and device type; and
(g) calculating said royalty.

2. The method of claim 1, wherein said file is selected from a group comprising:
(a) an audio file; and
(b) a video file.

3. The method of claim 1, wherein said calculation further comprises the step of determining said device decay rate based upon said device age and type.

4. The method of claim 3, wherein said calculation further comprises the step of determining an annual exceeded payout decay rate.

5. The method of claim 4, further comprising the steps of:
(a) first multiplying said device decay rate by said annual exceeded payout decay rate to determine total;
(b) second multiplying said total by said partner contract tail decay rate to determine a second total; and
(c) third multiplying said second total by a royalty rate for a particular territory via a song label and a device type before being multiplied by a calculated decay rate.

6. The method of claim 1, wherein said calculated royalty for said played file is assigned to a label account established for a label and accumulated in said label account with all other files associated with said label account until a predetermined time or event has occurred, then making a payment to said label in respect of said accumulated royalty.

7. The method of claim 1, further comprising the step of making a payment in respect of said royalty wherein said payment is sent via merchant ACH transfer to an individual label via a merchant gateway API.

8. A system for determining, within a data processing system, a royalty to be paid for use of a file, said system comprising:
(a) embedding means for embedding a set of license data within said file;
(b) scanner means for scanning said embedded set of license data within said file to determine a set of metrics for said file;
(c) a player device for playing said file within a specified territory;
(d) a register of each instance that said file is played and further comprising an aggregate of set of total instances; and
(e) a calculation routine for initiating, within said data processing system, a determination by territory and device type, of a royalty in respect of said metrics.

9. The system of claim 8, wherein said file is selected from a group comprising:
(a) an audio file; and
(b) a video file.

10. The system of claim 8, wherein said file further comprises a limitation on a territory within which said file can be played.

11. The system of claim 8, wherein said player device further comprises a profile, said profile being uploadable to said system so as to determine said device's age.

12. The system of claim 8, wherein said player device further comprises interface means for interfacing said player device with said system via an Internet application.

13. The system of claim 8, wherein said player device further comprises a memory for storing a set of data relative to one or more plays of one or more files for download to said system.

14. The system of claim 8, further comprising calculating means for determining said device decay rate based upon said device age and type.

15. The system of claim 8, further comprising calculating means for determining an annual exceeded payout decay rate.

16. The system of claim 8, further comprising:
(a) first multiplying means for multiplying said device decay rate by said annual exceeded payout decay rate to determine total;
(b) second multiplying means for multiplying said total by said partner contract tail decay rate to determine a second total; and
(c) third multiplying means for multiplying said second total by a royalty rate for a particular territory via a song label and a device type before being multiplied by a calculated decay rate.

17. A method for determining, a royalty to be paid for use of a file within a social networking system, said method comprising the steps of:
(a) scanning an embedded license within said file to determine a set of metrics related thereto;
(c) allowing said file to be played by a device within a specified territory if said file metrics are compatible with a set of pre-determined criteria, and not allowing said file to be played if said metrics are not compatible;
(d) accumulating in a register of said system each instance that said file is played and aggregating a set of total instances;
(e) initiating a calculation routine within said data processing system for determining a royalty in respect of said aggregated instances;
(f) determining said royalty by territory and device type; and
(g) assigning said determined royalty for said played file to a label account established for a label and accumulated in said label account with all other files associated with said label account until a predetermined time or event has occurred, then making a payment to said label in respect of said accumulated royalty.

18. The method of claim 1, wherein said file is selected from a group comprising:
(a) an audio file;
(b) a video file; and
(c) a mixed media file.

19. The method of claim 17, wherein said calculation further comprises the step of determining said device decay rate based upon said device age and type.

20. The method of claim 17, wherein said calculation further comprises the step of determining an annual exceeded payout decay rate.

21. A method for determining and distributing a set of payments within an audio/video file distribution system, based on the use of a digital audio/video enabled device by an end user, said method comprising the steps of:
(a) establishing an access network for access to one or more repositories of a set of digital audio/video files;
(b) installing a program in one or more of said digital audio/video enabled devices, wherein said program is capable of accessing, reading, aggregating, storing and reporting a plays per file per user when said user accesses and downloads a single one or more of said digital audio/video files;
(c) selecting from a display of said digital audio/video enabled device, a digital audio/video file resident at at least one of said one or more repositories;
(d) downloading said digital audio/video file to said digital audio/video enabled device;
(e) creating and storing a record of said plays and said downloads within a memory of said audio/video file distribution system;
(f) aggregating in accordance with a predetermined profile, one or more sets within said audio/video file distribution system, each of said records stored within said audio/video file distribution system; and
(g) generating a payment to a stakeholder of each of said one or more sets, said payment representative of a certain data set contained within each of said aggregated records.

22. The method of claim 21, wherein said selection step (c) further comprises the steps of:
(a) accessing an intelligent search field from the display of said digital audio/video enabled device;
(b) selecting a category of search from a list of categories;
(c) entering a name or parameter associated with said selected category;
(d) searching said one or more repositories for a specific digital audio/video file representative of said entered name or parameter; and,
(i) if locating a match between said entered name or parameter and a file resident within said one or more repositories, than displaying a file name of said matched file; and,
(ii) if no match is made, then displaying a no match indication to a user of said digital audio/video enabled device;
(e) selecting said matched file name for download from said repository to said digital audio/video enabled device.

23. The method of claim 21, wherein said digital audio/video internet enabled device acts as a user portal to access and participate in a social networking exchange hosted by said audio/video file distribution system, said access and participation comprising the steps of
(a) embedding a routine in said audio/video file distribution system for allowing said user to select from a menu displayed on said digital audio/video internet enabled device an option to enter said social networking exchange;
(b) selecting, by said user, said option;
(c) entering said social networking exchange; and
(d) posting by said user, within a field of said social networking exchange, a short string message.

24. A method for producing, in an audio/video file distribution system, a customized report representative of music or video play historical data for a set of one or more digital audio/video enabled devices, said method comprising the steps of:
(a) establishing an access network for access to one or more repositories of a set of digital audio/video files;
(b) installing a program in one or more of said digital audio/video enabled devices, wherein said program is capable of accessing and reading plays of a single one or more of said digital audio/video files;
(c) selecting from a display of a digital audio/video enabled device, a digital audio/video file resident at least one of said one or more repositories;
(d) downloading said digital audio/video file to said digital audio/video enabled device;
(e) creating and storing a record of said play, and any subsequent plays from said digital audio/video enabled device, within a memory of said audio/video file distribution system;
(f) aggregating all records created for each one of said one or more digital audio/video enabled devices;
(g) creating a custom report format representative of one or more custom reports;
(h) requesting a first one of said one or more custom reports;
(i) populating said format corresponding to said one custom report with a set of data requested by said format and contained within said aggregated records; and
(j) producing said custom report.
